(19) United States
(12) Patent Application Publication
(10) Pub. No.: US 2015/0048110 A1
(43) Pub. Date: Feb. 19, 2015

(54) Coconut Valve

(71) Applicant: Paul dePoo, Key West, FL (US)

(72) Inventor: Paul dePoo, Key West, FL (US)

(21) Appl. No.: 13/968,255

(22) Filed: Aug. 15, 2013

(51) Int. Cl. A23N 1/00; A23N 5/03; A23L 2/04

(52) U.S. Cl. CPC A23N 1/00; A23L 2/04; A23N 5/03
USPC 222/83; 29/428

(57) ABSTRACT

A resealable spigot for a coconut that provides easy access by consumers to the sterile coconut water within a coconut. The spigot is comprised of a grommet positioned within a coconut tooled cavity, a sleeve positioned with said grommet and a plunger positioned within said sleeve with the plunger selectively movable to breech the coconut's seed-case cavity providing access to the sterile coconut water therein.

### BACKGROUND OF THE INVENTION

1. Field of the Invention

The present invention relates generally to spigots and, more specifically, to a tap for a container spigot for a coconut that provides easy access by consumers to the sterile coconut water within a coconut by pushing the partially inserted spigot to its seated position.

Initially the spigot is inserted through the shell or soft eye of the husk and into the coconut meat with the spigot's conduit distal end positioned outside the coconut seed-case cavity maintaining the sterile condition of the coconut water within the seed-case cavity until access of the coconut water is desired, where then spigot access to the coconut water is accomplished by applying manual pressure to the plunger driving the plunger's conduit distal end into the seed-case cavity providing access to the sterile coconut water.

2. Description of the Prior Art

There are other spigot devices designed for containers. While these spigots may be suitable for the purposes for which they where designed, they would not be as suitable for the purposes of the present invention as heretofore described.

It is thus desirable to provide a spigot for a coconut that will allow a consumer to easily extract the sterile coconut water within a coconut It is further desirable to use the coconut as opposed to re-packaging the coconut water since the coconut is biodegradable and the coconut water remains sterile while contained within the nut.

### SUMMARY OF THE PRESENT INVENTION

A machine for boring at least one cavity in a coconut with the cavity forming receptacle for placement therein of a pressure actuatable spigot to breech the coconut seed-case cavity to extract the coconut water when desired.

Another object of the present invention is to provide a coconut boring machine having a workpiece platform supporting a workpiece with a boring apparatus boring the shell with selective boring machine components preferably made of stainless steel for food grade use.

Yet another object of the present invention is to provide a coconut spigot comprising a grommet fixedly attached over the coconut's soft eye with a lancing spigot positioned within the soft eye until sufficient pressure is applied to the plunger to breech the seed-cavity cavity enabling the retrieval of the sterile coconut water through spigot or straw inserted into seed-case cavity through spigot conduit.

A further object of the present invention is to provide a spigot having a grommet with a flange portion and a collar portion having a plurality of ring-like ridges that engage the wall of a coconut tooled cavity forming a compression fitting for the spigot.

A still yet further object of the present invention is to provide a spigot having a flanged sleeve with transverse bored collars on opposing sides with one sleeve collar having a terminus ridge inserted into the grommet bore until mating the grommet flange with the sleeve flange wherethen the terminus ridge forms seat for the grommet.

Another object of the present invention is to provide a spigot having a plunger movably positionable within the sleeve bore whereby manual pressure applied to the plunger will breech the coconut seed-core cavity.

Still yet another object of the present invention is to provide access means for a consumer to easily retrieve sterile coconut water from a coconut's seed core cavity.

An additional object of the present invention is to provide a coconut having a spigot as means for accessing the coconut's water so that the consumer can easily retrieve the coconut water from a coconut while in its sterile state.

A further object of the present invention is to provide a coconut with a spigot partially inserted into a coconut that requires only manual pressure applied to the plunger to breech the coconut's seed-case cavity when it is desired to retrieve the coconut water in its sterile state from said coconut seed-case cavity.

A yet further object of the present invention is to provide access to coconut water within a coconut by initially inserting the spigot through the shell without piercing the meat or coconut water cavity.

Yet another object of the present invention is to provide easy access by consumers to the coconut water within a coconut without compromising its sterile contents.

Still yet another object of the present invention is to provide a spigot that will provide access to the coconut water within a coconut by a consumer pressing the plunger spigot through the remainder of the coconut meat and into the coconut water cavity.

A yet further object of the present invention is to provide a straw that may have a filter on one end to prevent pulp from being drawn in.

Yet another object of the present invention is to provide a spigot having a plunger that is movable from a blocking position to an unblocking position so that the coconut water can be poured into a glass.

Still yet another object of the present invention is to provide two valves to provide a vent for better water flow.

Additional objects of the present invention will appear as the description proceeds.

The present invention overcomes the shortcomings of the prior art by providing to a tap for a container spigot for a coconut that provides easy access by consumers to the sterile coconut water within a coconut by pushing the partially inserted spigot to its seated position. Initially the spigot is inserted through the shell or soft eye of the shell and into the coconut meat with the spigot's conduit distal end positioned outside the coconut seed-case cavity maintaining the sterile condition of the coconut water within the seed-case cavity until access of the coconut water is desired, where then spigot access to the coconut water is accomplished by applying manual pressure to the plunger driving the plunger's distal end into the seed-case cavity providing access to the sterile coconut water.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is a perspective assembly view of an embodiment of the spigot of the present invention.

FIG. 2A through 2E is an illustrative view of an embodiment of the plunger.

FIG. 3A through 3E is an illustrative view of another embodiment of the plunger.

FIG. 4A through 4D is an illustrative view of still another embodiment of the plunger.

FIG. 5A through 5E shown is an illustrative view of an embodiment of the spigot sleeve.

FIG. 6A through 6H shown is another illustrative view of an embodiment of the spigot sleeve.

FIG. 7A through 7H is still another illustrative view of an embodiment of the spigot sleeve.

FIG. 8A through 8D is an illustrative view of an embodiment of the spigot grommet.

FIG. 9A through 9D shown is an illustrative view of another embodiment of the spigot grommet.

FIG. 10A through 10D is an illustrative view of another embodiment of the spigot grommet.

FIG. 11 is an exploded view of the coconut spigot of the present invention.

FIG. 12 is another exploded view of an enablement of the coconut spigot of the present invention.

FIG. 13A through 13F is an illustrative view of another embodiment of the plunger.

FIG. 14A through 14D is an illustrative view of another embodiment of the spigot grommet.

FIG. 15A through 15I is another illustrative view of an embodiment of the spigot sleeve.

FIGS. 16A through 16D is the plunger cap of the spigot of the present invention.

FIG. 17 is an assembled view of the coconut spigot of the present invention.

FIG. 18 is an exploded view of the coconut spigot of the present invention.

FIG. 19 is another exploded view of an enablement of the coconut spigot of the present invention.

FIG. 20 is an illustrative view of another embodiment of the plunger.

FIG. 21 is an end view of an enablement of the plunger of the present invention.

FIG. 22 is an exploded end view of an enablement of the plunger of the present invention.

FIG. 23 is an exploded view of an enablement of the plunger of the present invention.

FIG. 24 is an exploded end view of an enablement of the plunger of the present invention.

FIG. 25 is an exploded perspective view of an enablement of the plunger of the present invention.

FIG. 26 is an assembled perspective view of an enablement of the plunger of the present invention.

FIG. 27 is an assembled perspective view of an enablement of the plunger of the present invention

FIG. 28 is another illustrative view of an embodiment of the spigot sleeve.

FIG. 29 is an assembled view of the coconut spigot plunger deployed.

FIG. 30 is an assembled view of the coconut spigot plunger deployed.

FIG. 31 is an assembled view of the coconut spigot plunger deployed.

FIG. 32 is an assembled view of the coconut spigot plunger deployed.

FIG. 33 is a coconut having a value positioned within a cavity.

FIG. 34 is a coconut having a value positioned within a cavity.

FIG. 35 is another enablement of the coconut spigot of the present invention.

FIG. 36 is an illustrative view of the boring machine of the present invention.

FIG. 37 is a perspective view of the boring machine of the present invention.

FIG. 38 is a front view of the boring machine of the present invention.

FIG. 39 is an illustrative view of a coconut.

FIG. 40 is an illustrative view of a spigot for a coconut soft eye.

FIG. 41A through 41D is an illustrative view of a coconut aperture plug.

FIG. 42A through 42D is an illustrative view of additional embodiment of the plunger.

FIGS. 43 and 44, shown are exploded views of an enablement of the coconut spigot of the present invention.

FIG. 45 is an illustrative view of an embodiment of the spigot grommet.

FIG. 46 is an illustrative view of a coconut aperture plug.

FIG. 47 is an illustrative view of another enablement of the coconut aperture plug.

FIG. 48 is an illustrative view of a plunger seated within a grommet.

FIG. 49 is an illustrative view of a coconut.

FIG. 50 is a coconut with a milled bore.

FIG. 51 is a coconut with a milled bore and grommet.

FIG. 52 is a coconut with a seated grommet.

FIG. 53 is a coconut with a seated grommet and plunger.

FIG. 54 is a coconut with a seated grommet and plunger.

FIG. 55 is a coconut with a seated grommet.

FIGS. 56 and 57 are a coconut with a seated grommet.

FIGS. 58 through 62 is a progression of illustrations of the method for accessing coconut water.

FIG. 63 is another enablement of a coconut spigot of the present invention.

### DESCRIPTION OF THE REFERENCED NUMERALS

Turning now descriptively to the drawings, in which similar reference characters denote similar elements throughout the several views, the figures illustrate the Coconut with Spigot of the present invention. With regard to the reference numerals used, the following numbering is used throughout the various drawing figures.
10 Coconut Spigot of the present invention
12 coconut
14 coconut husk
16 coconut seed
18 coconut seed-case
20 coconut meat
22 coconut seed-case cavity
24 coconut water
26 plunger
28 plunger sleeve
30 grommet
32 flange of 26
34 top of 32
36 bottom of 32
38 arm of 32
40 grip of 26
42 ringlet of 40
44 conduit of 26
46 sleeve seat gasket of 26
48 conical portion of 44
50 cylindrical portion of 44
52 end of 44
54 bore of 44
56 rails of 44
58 slots of 44
60 detachable tip of 44
62 collar of 32
64 rim of 62
66 flange of 28
68 collar of 28
70 ridge of 68
72 sleeve seat
74 sleeve membrane
76 grommet seat collar
78 lip of 76
80 sleeve bore
82 grommet flange
84 grommet collar
86 grommet gasket
88 grommet bore
90 boring device
92 boring bit
94 workpiece platform
96 cap of 62
98 channel of 96
100 tab of 96
102 straw
104 coconut eyes
106 soft eye of 102
108 bond
110 coconut band
112 plug
114 plug handle
116 plug flange
118 grommet seat
120 plug collar
122 plug bore
124 handle of 26
126 coring cavity of 26
128 stop of 26
130 gasket of 112
132 gasket of 26
134 drilled aperture
136 wall of 134
138 mini plug

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

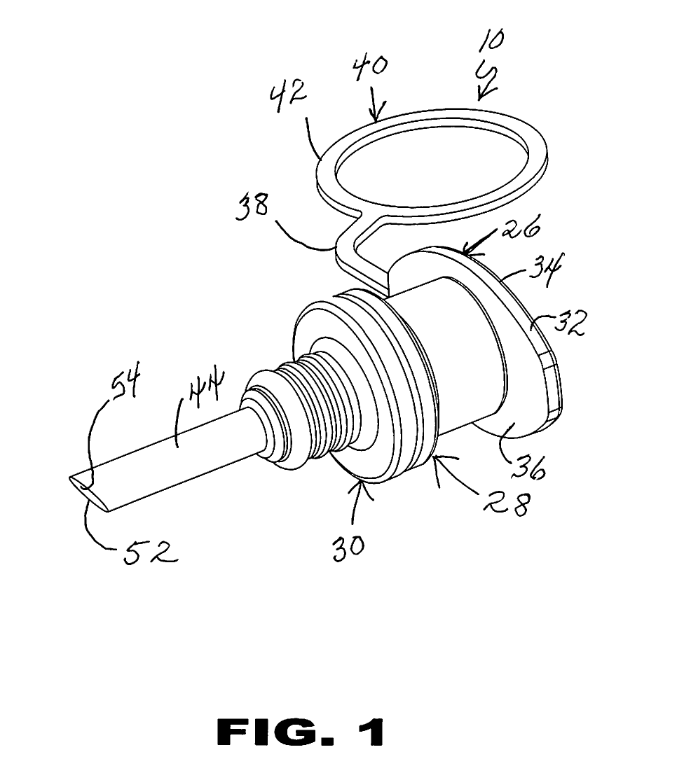

Referring to FIG. 1, shown is a perspective assembly view of an embodiment of the spigot of the present invention. The present invention 10 provides a spigot 28 that is partially inserted into the coconut shell and not the meat and then shipped to consumers who then complete inserting the plunger 28 through the coconut meat into the coconut seed-case cavity providing access to the sterile coconut water. As illustrated, the spigot 10 comprises plunger 26, sleeve 28 and grommet 30. Plunger 26 has arm 38 and ringlet 42 forming plunger grip 40. The plunger further provides flange 32 having top surface 34 and bottom surface 36 having conduit 44 with bore 54 extending therefrom terminating in end 52. Sleeve 28 mounts onto conduit 44 with grommet 30 mounting onto sleeve 28.

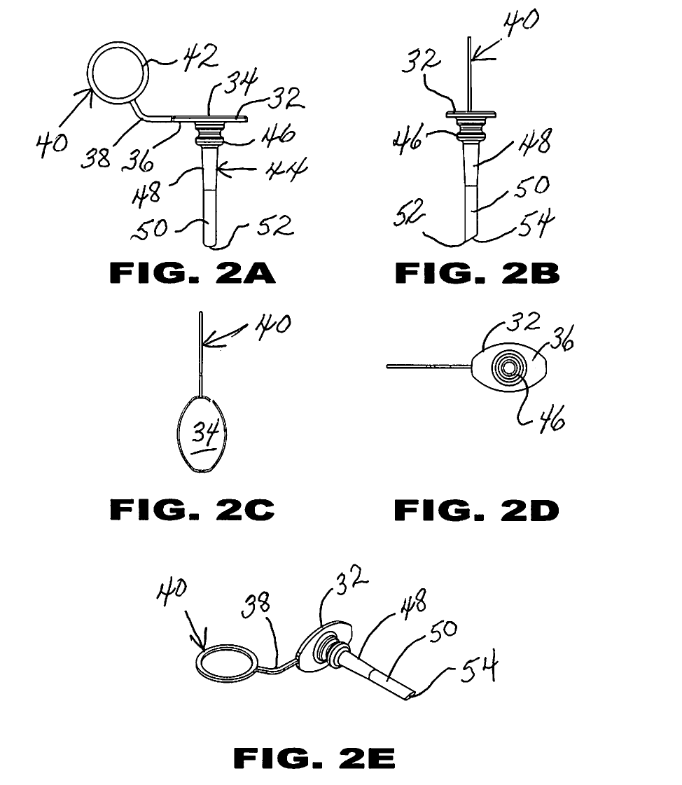

Referring to FIG. 2A through 2E shown is an illustrative view of an embodiment of the plunger. Plunger 26 has arm 38 and ringlet 42 forming plunger grip 40. The plunger further provides flange 32 having top surface 34 and bottom surface 36 with conduit 44 having bore 54 extending from the flange bottom surface 36. Conduit 44 provides for a conduit having a conical portion 48 and a cylindrical portion 50 with the flange end of the conduit having a sleeve seat gasket 46 mateable to the sleeve seat.

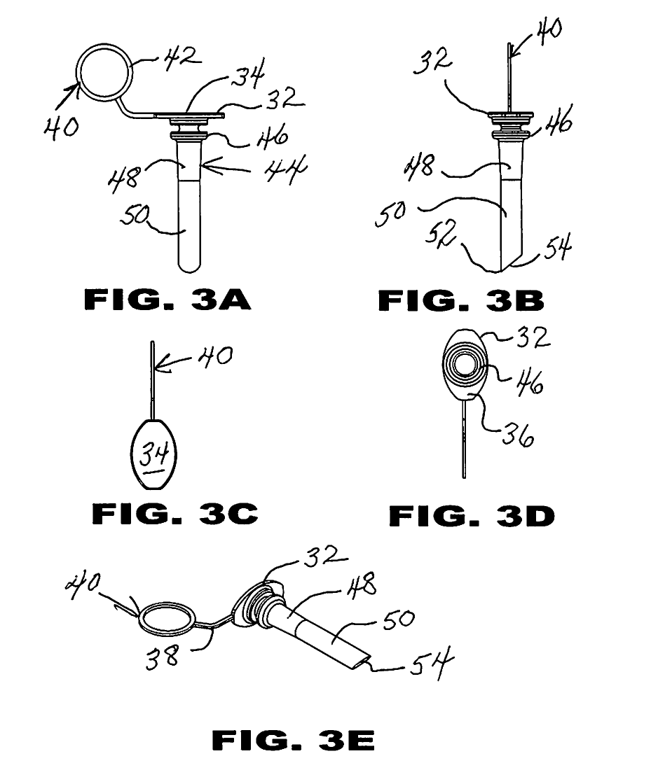

Referring to FIG. 3A through 3E shown is an illustrative view of another embodiment of the plunger. Plunger 26 has arm 38 and ringlet 42 forming plunger grip 40. The plunger further provides flange 32 having top surface 34 and bottom surface 36 with conduit 44 having bore 54 extending from the flange bottom surface 36. Conduit 44 provides for a conduit having a conical portion 48 and a cylindrical portion 50 with the flange end of the conduit having a sleeve seat gasket 46 mateable to the sleeve seat.

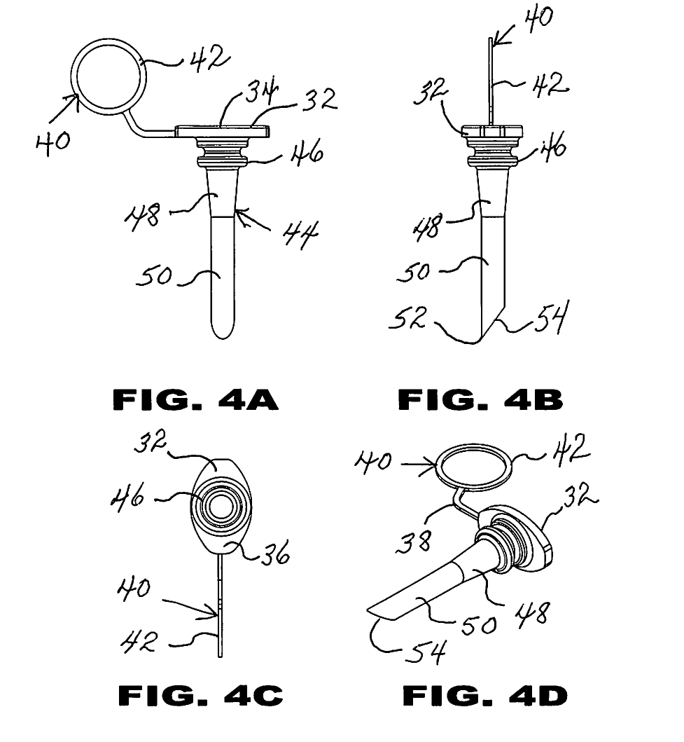

Referring to FIG. 4A through 4D shown is an illustrative view of still another embodiment of the plunger. Plunger 26 has arm 38 and ringlet 42 forming plunger grip 40. The plunger further provides flange 32 having top surface 34 and bottom surface 36 with conduit 44 having bore 54 extending from the flange bottom surface 36. Conduit 44 provides for a conduit having a conical portion 48 and a cylindrical portion 50 with the flange end of the conduit having a sleeve seat gasket 46 mateable to the sleeve seat.

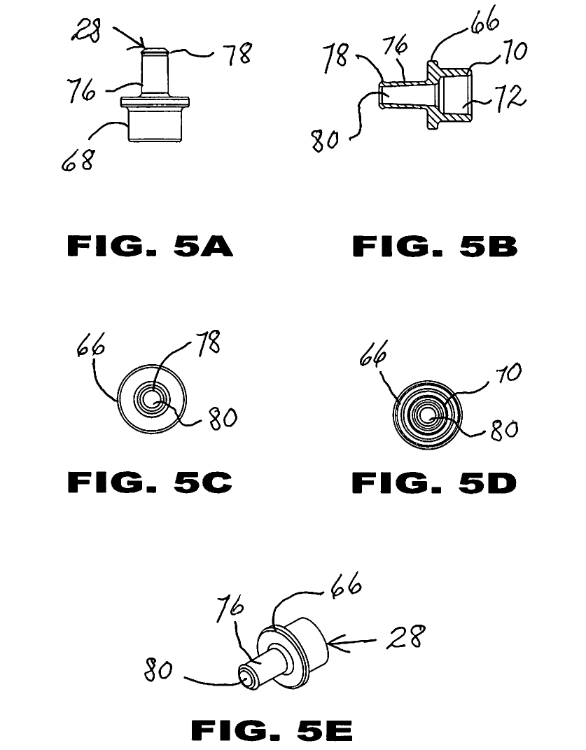

Referring to FIG. 5A through 5E shown is an illustrative view of an embodiment of the spigot sleeve. Sleeve 28 having bore 80 has flange 66 with opposing side collars extending therefrom. Collar 68 forms sleeve seat 72 receiving sleeve seat gasket 46 and collar 76 forms grommet seat collar 76 having lip 78 as stop for grommet 30 mounted thereon.

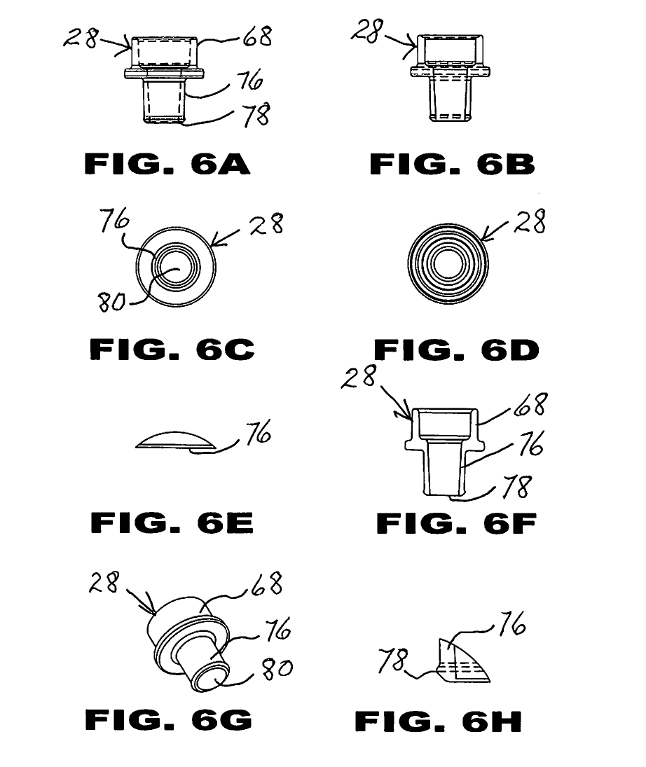

Referring to FIG. 6A through 6H shown is another illustrative view of an embodiment of the spigot sleeve. Sleeve 28 having bore 80 has flange 66 with opposing side collars extending therefrom. Collar 68 forms sleeve seat 72 receiving sleeve seat gasket 46 and collar 76 forms grommet seat collar 76 having lip 78 as stop for grommet 30 mounted thereon.

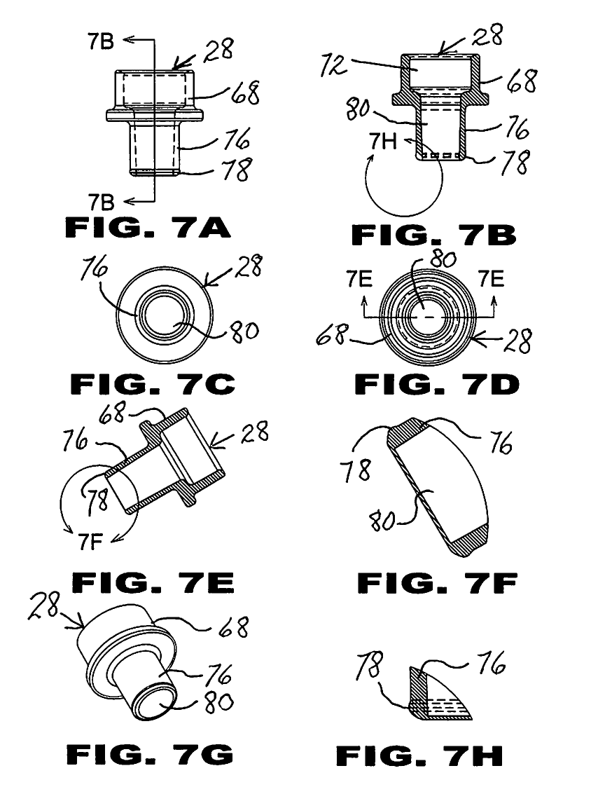

Referring to FIG. 7A through 7H shown is still another illustrative view of an embodiment of the spigot sleeve. Sleeve 28 having bore 80 has flange 66 with opposing side collars extending therefrom. Collar 68 forms sleeve seat 72 receiving sleeve seat gasket 46 and collar 76 forms grommet seat collar 76 having lip 78 as stop for grommet 30 mounted thereon.

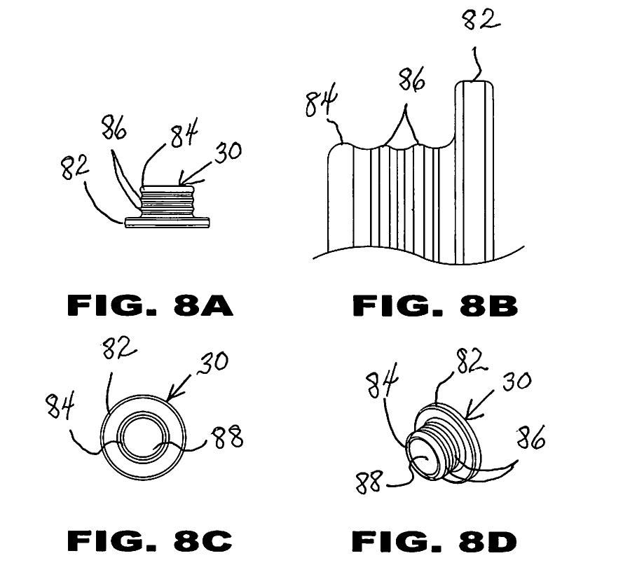

Referring to FIG. 8A through 8D shown is an illustrative view of an embodiment of the spigot grommet. Grommet 30 holds spigot 10 within a cavity drilled in the coconut wall with flange 82 seated against the rim of the cavity. Grommet collar 84 has ridges 86 serving as grommet gasket. Grommet bore 88 enable mounting of the spigot sleeve within bore 88.

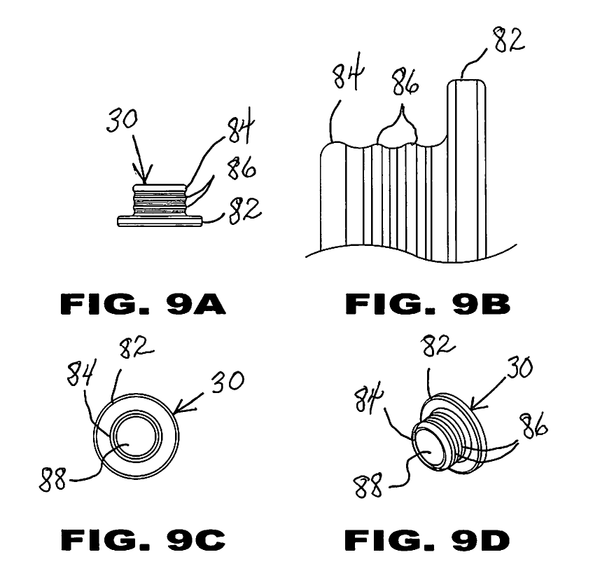

Referring to FIG. 9A through 9D shown is an illustrative view of another embodiment of the spigot grommet. Grommet 30 holds spigot 10 within a cavity drilled in the coconut wall with flange 82 seated against the rim of the cavity. Grommet collar 84 has ridges 86 serving as grommet gasket. Grommet bore 88 enable mounting of the spigot sleeve within bore 88.

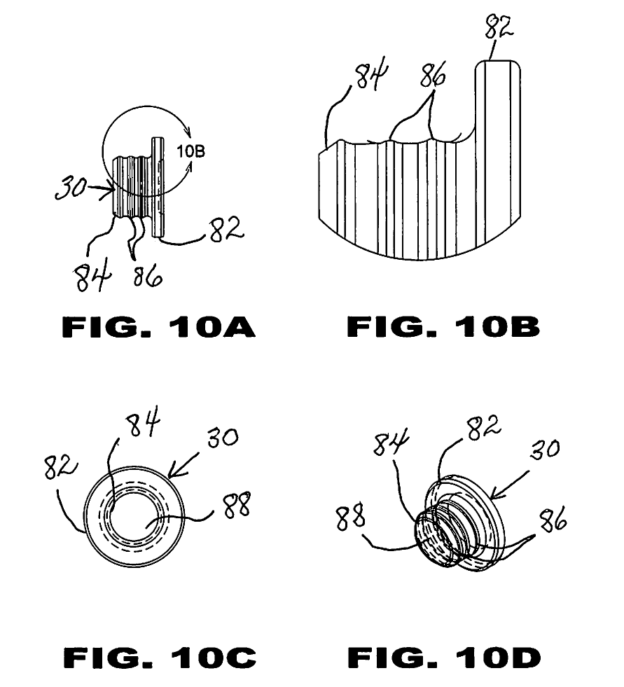

Referring to FIG. 10A through 10D shown is an illustrative view of another embodiment of the spigot grommet. Grommet 30 holds spigot 10 within a cavity drilled in the coconut wall with flange 82 seated against the rim of the cavity. Grommet collar 84 has ridges 86 serving as grommet gasket. Grommet bore 88 enable mounting of the spigot sleeve within bore 88.

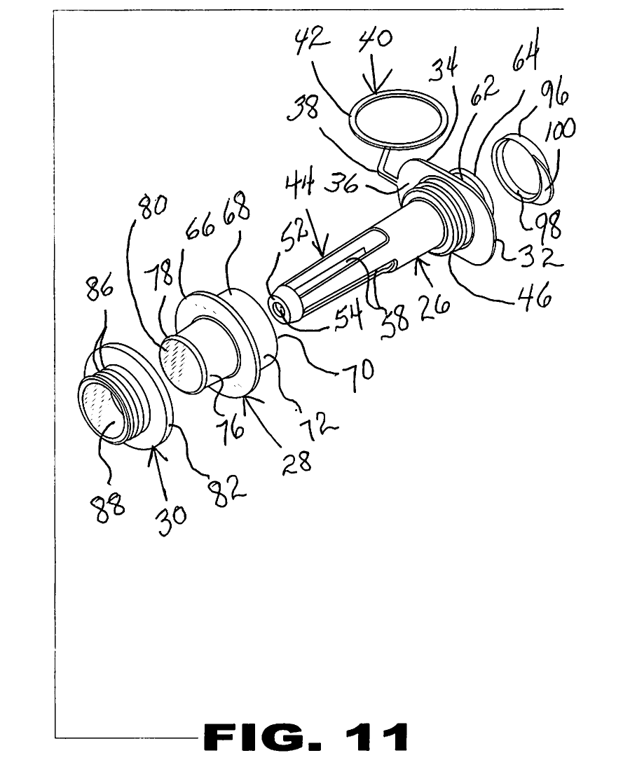

Referring to FIG. 11, shown is an exploded view of the coconut spigot of the present invention. Depicted is the coconut spigot 10 comprising plunger 26, sleeve 28 and grommet 30. Grommet 30 has flange 82 and collar 84 with ridges 86 with the grommet seated within a cavity drilled within the coconut wall. Sleeve 28 having bore 80 has flange 66 with opposing side collars 68, 76 extending from flange. 66. Sleeve collar 68 is sleeve seat 72 receiving plunger sleeve gasket 46 with sleeve collar 76 having lip 78 forms seat for grommet 30 to be mounted onto collar 76.

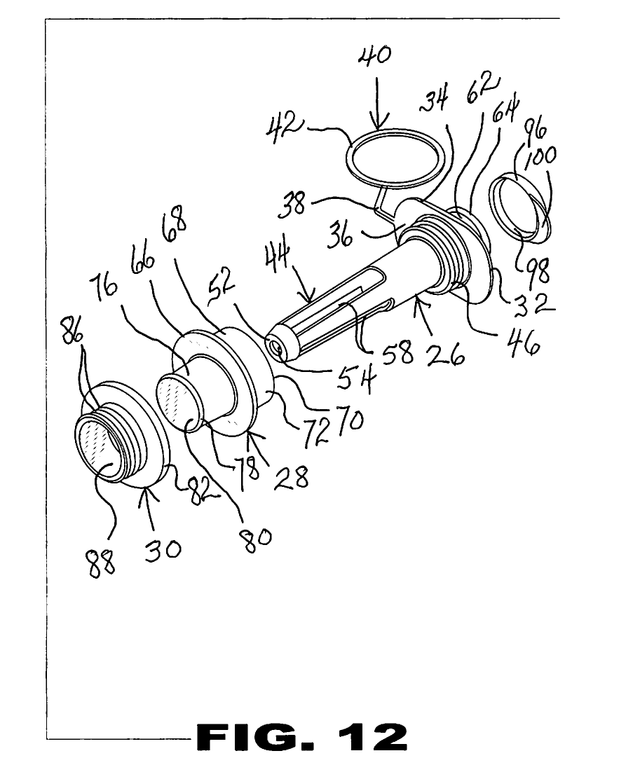

Referring to FIG. 12, shown is another exploded view of an enablement of the coconut spigot of the present invention. Depicted is the coconut spigot 10 comprising plunger 26, sleeve 28 and grommet 30. Grommet 30 has flange 82 and collar 84 with ridges 86 with the grommet seated within a cavity drilled within the coconut wall. Sleeve 28 having bore 80 has flange 66 with opposing side collars 68, 76 extending from flange. 66. Sleeve collar 68 is sleeve seat 72 receiving plunger sleeve gasket 46 with sleeve collar 76 having lip 78 forms seat for grommet 30 to be mounted onto collar 76 via bore 88 with sleeve bore 80 providing for movement of plunger conduit 44 therein.

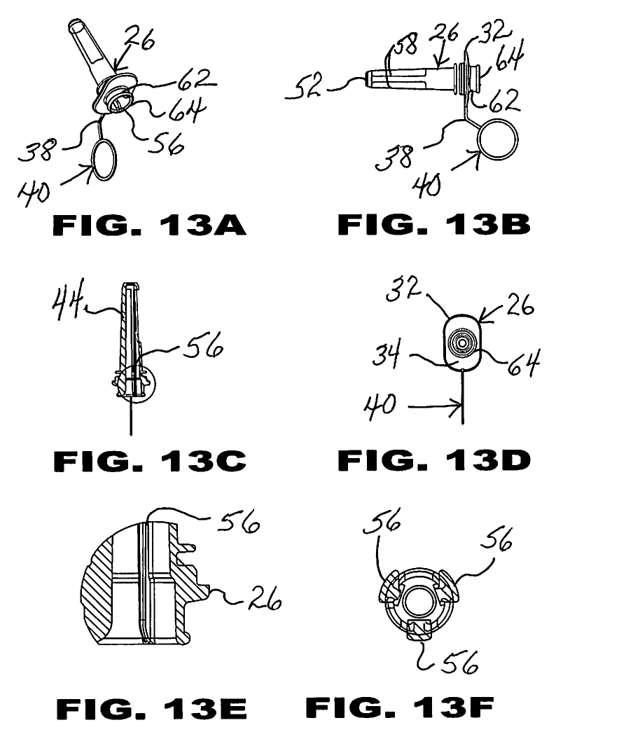

Referring to FIG. 13A through 13F shown is an illustrative view of another embodiment of the plunger. Plunger 26 has arm 38 and ringlet 42 forming plunger grip 40. The plunger further provides flange 32 having top surface 34 and bottom surface 36 with conduit 44 having bore 54 extending from the flange bottom surface 36. Conduit 44 additionally provides for a conduit having additional elements in the form of slots within the plunger conduit wall 44. Also provided is a plurality of rails 56 within the bore of conduit 44.

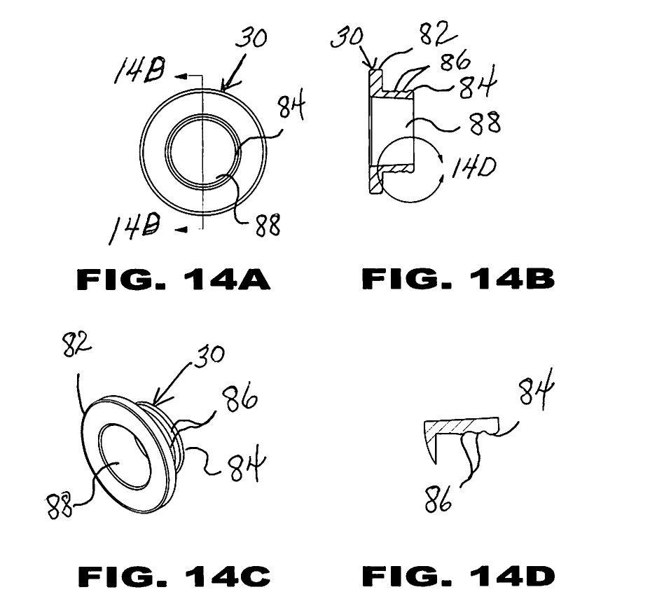

Referring to FIG. 14A through 14D shown is an illustrative view of another embodiment of the spigot grommet. Grommet 30 holds spigot 10 within a cavity drilled in the coconut wall with flange 82 seated against the rim of the cavity. Grommet collar 84 has ridges 86 serving as grommet gasket. Grommet bore 88 enable mounting of the spigot sleeve within bore 88.

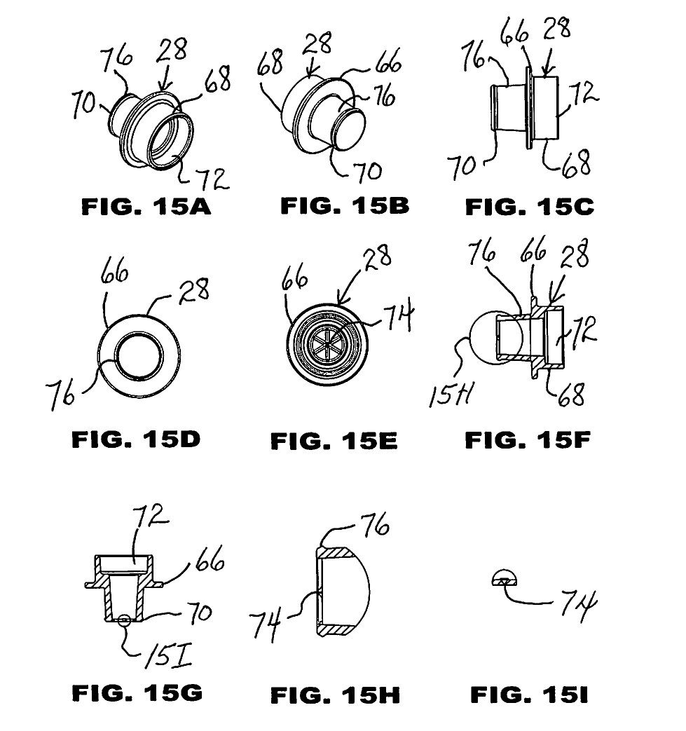

Referring to FIG. 15A through 151 shown is another illustrative view of an embodiment of the spigot sleeve. Sleeve 28 has bore 80 with flange 66 having opposing side collars extending therefrom. Collar 68 forms sleeve seat 72 receiving sleeve seat gasket 46 and collar 76 forms grommet seat collar 76 having lip 78 as stop for grommet 30 mounted thereon. Also shown is sleeve 28 having sleeve membrane 74 which can be punctured by the plunger 26 to retrieve the coconut water from the seed-case cavity.

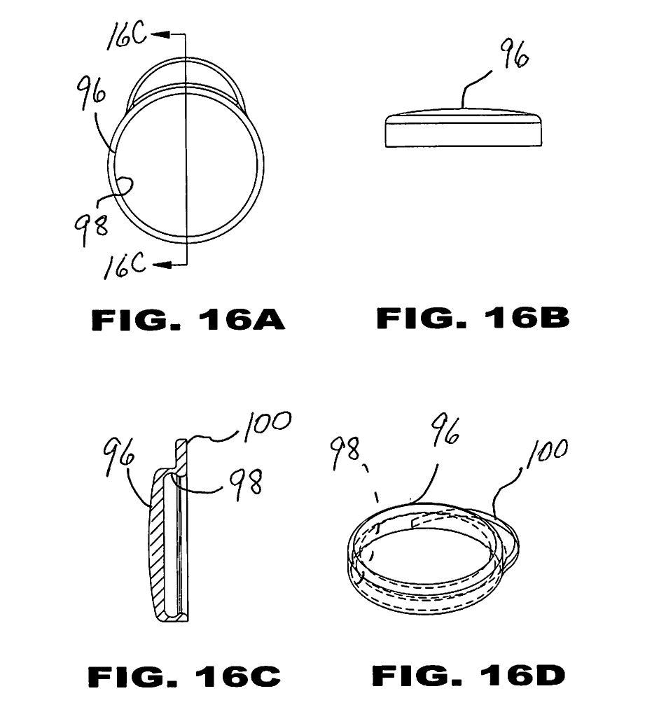

Referring to FIGS. 16A through 16D, shown is the plunger cap of the spigot of the present invention. An enablement of the plunger cap of the present invention provides for conduit 44 to extend through flange 32 forming flange collar 62 having rim 64 with the plunger flange 32 having arm 38 with cap 96 having tab 100 and cap channel 98 receiving collar rim 64 therein.

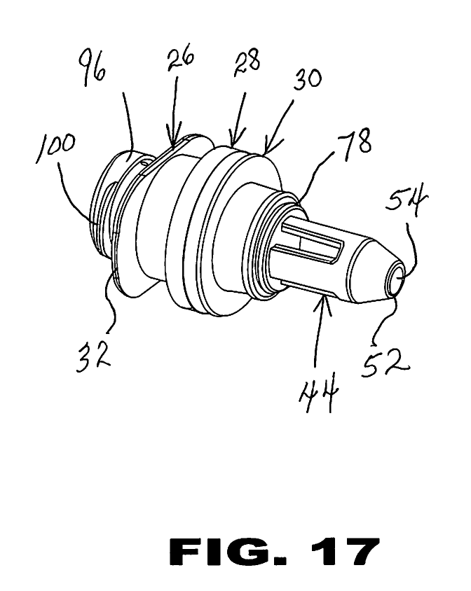

Referring to FIG. 17, shown is an assembled view of the coconut spigot of the present invention. Depicted is the coconut spigot 10 comprising plunger 26, sleeve 28 and grommet 30. Grommet 30 is seated on sleeve 28 collar 76 and is retained by rim 78. Sleeve 28 has bore 80 extending from flange. 66. Sleeve collar 68 is sleeve seat 72 receiving plunger sleeve gasket 46.

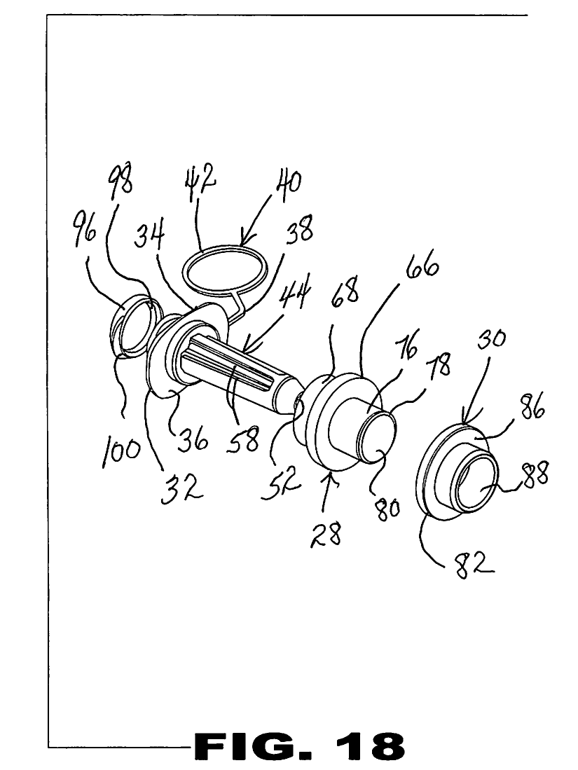

Referring to FIG. 18, shown is an exploded view of the coconut spigot of the present invention. Depicted is coconut spigot 10 comprising plunger 26, sleeve 28 and grommet 30. Grommet 30 has flange 82 and collar 84 with ridges 86 with the grommet seated within a cavity drilled within the coconut wall. Sleeve 28 having bore 80 has flange 66 with opposing side collars 68, 76 extending from flange. 66. Sleeve collar 68 is sleeve seat 72 receiving plunger sleeve gasket 46 with sleeve collar 76 having lip 78 forms seat for grommet 30 to be mounted onto collar 76.

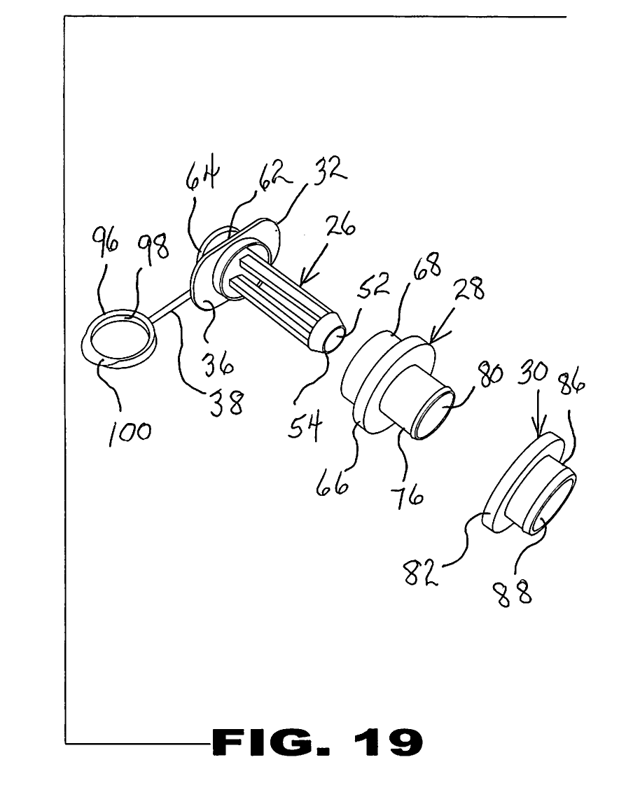

Referring to FIG. 19, shown is another exploded view of an enablement of the coconut spigot of the present invention. Depicted is coconut spigot 10 comprising plunger 26, sleeve 28 and grommet 30. Grommet 30 has flange 82 and collar 84 with ridges 86 with the grommet seated within a cavity drilled within the coconut wall. Sleeve 28 having bore 80 has flange 66 with opposing side collars 68, 76 extending from flange. 66. Sleeve collar 68 is sleeve seat 72 receiving plunger sleeve gasket 46 with sleeve collar 76 having lip 78 forms seat for grommet 30 to be mounted onto collar 76.

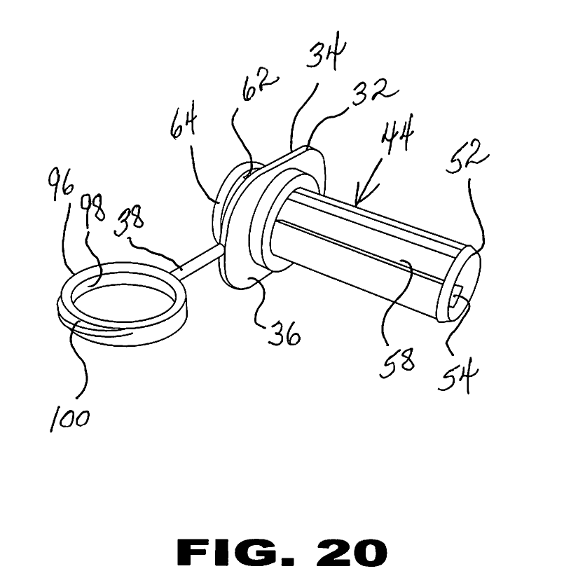

Referring to FIG. 20 shown is an illustrative view of another embodiment of the plunger. Plunger 26 has arm 38 and cap 96 with channel 98 and tab 100 for closing the plunger sleeve conduit 54. The plunger further provides flange 32 having top surface 34 and bottom surface 36 with conduit 44 having bore 54 extending from collar 62 through end 52. Further provided are a plurality of slits 58 within conduit wall 44.

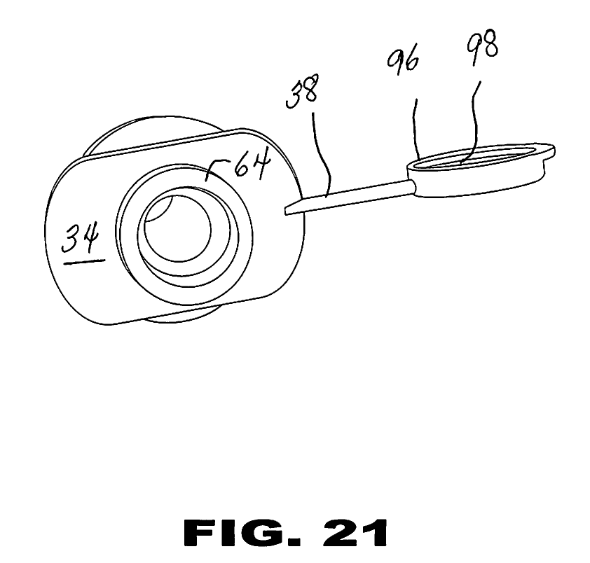

Referring to FIG. 21, shown is an end view of an enablement of the plunger of the present invention. Illustrated is the plunger 26 having arm 38 and cap 96 with channel 98 and tab 100 for closing the plunger sleeve conduit 54. The plunger further provides flange 32 having top surface 34 and bottom surface 36 with conduit 44 having bore 54 extending from collar 62 through end 52.

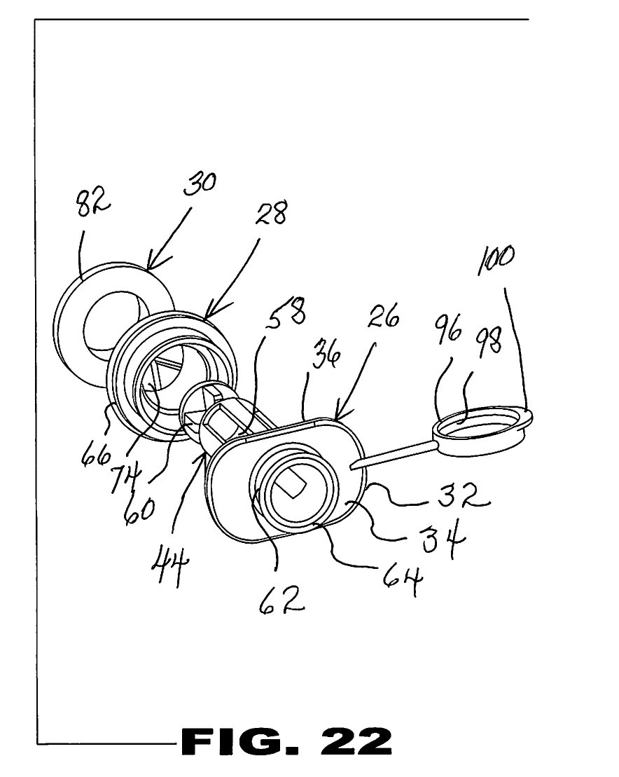

Referring to FIG. 22, shown is an exploded end view of an enablement of the plunger of the present invention. Illustrated is the plunger 26 having arm 38 and cap 96 with channel 98 and tab 100 for closing the plunger sleeve conduit 54. The plunger further provides flange 32 having top surface 34 and bottom surface 36 with conduit 44 having bore 54 extending from collar 62 through end 52. Also shown is plunger 28 having a burstable membrane 74 and plunger tip 60 so that pressure applied to the plunger uses tip 60 to break member 74 providing access to the coconut's contents.

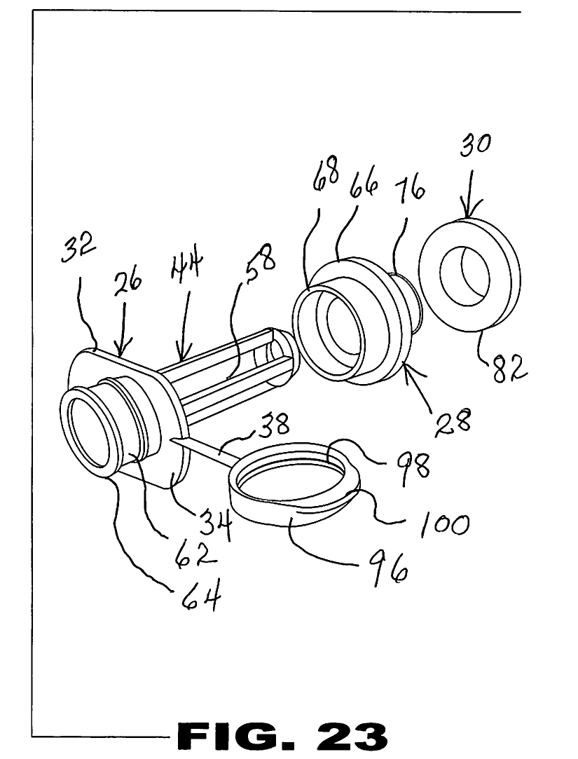

Referring to FIG. 23, shown is an exploded view of an enablement of the plunger of the present invention. Illustrated is the plunger 26 having arm 38 and cap 96 with channel 98 and tab 100 for closing the plunger sleeve conduit 54. The plunger further provides flange 32 having top surface 34 and bottom surface 36 with conduit 44 having bore 54 extending from collar 62 through end 52. Also shown is plunger 28 having a burstable membrane 74 and plunger sleeve 44 so that pressure applied to the plunger causes conduit 44 to break member 74 providing access to the coconut's contents.

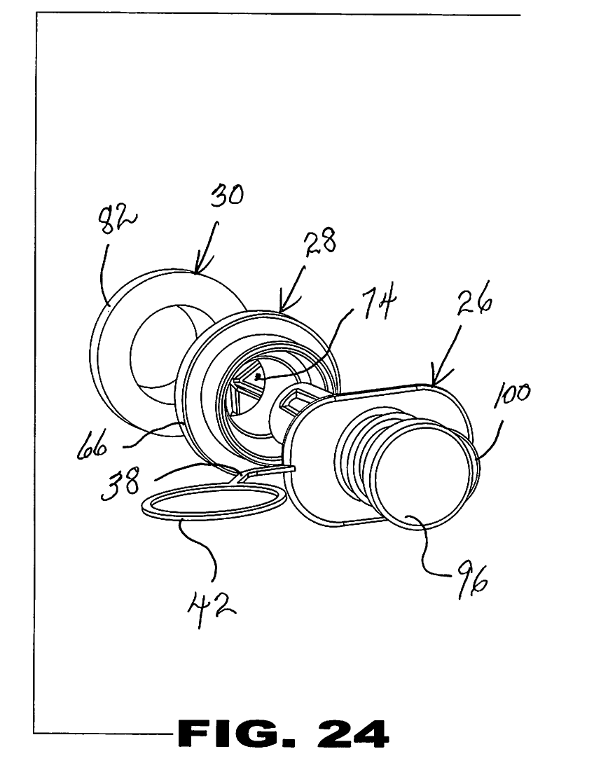

Referring to FIG. 24, shown is an exploded end view of an enablement of the plunger of the present invention. Illustrated is the plunger 26 having arm 38 and ringlet 42 forming plunger grip 40. The plunger further provides flange 32 having top surface 34 and bottom surface 36 with conduit 44 having bore 54 extending from collar 62 through end 52. Also shown is plunger 28 having a burstable membrane 74 so that pressure applied to the plunger causes conduit 44 to break member 74 providing access to the coconut's contents.

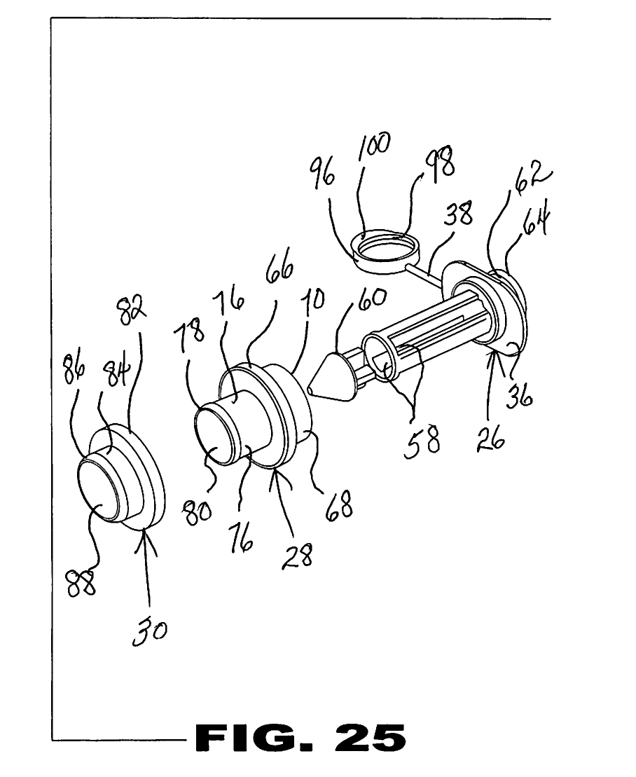

Referring to FIG. 25, shown is an exploded perspective view of an enablement of the plunger of the present invention. Illustrated is the plunger 26 having arm 38 and cap 96 with channel 98 and tab 100 for closing the plunger sleeve conduit 54. The plunger further provides flange 32 having top surface 34 and bottom surface 36 with conduit 44 having bore 54 extending from collar 62 through end 52. Also shown is plunger 28 having a burstable membrane 74 and plunger tip 60 positioned within conduit 44 end 52 so that pressure applied to plunger 26 causes tip 60 to break member 74 providing access to the coconut's contents. Also shown is conduit 44 having a plurality of wall slits 58.

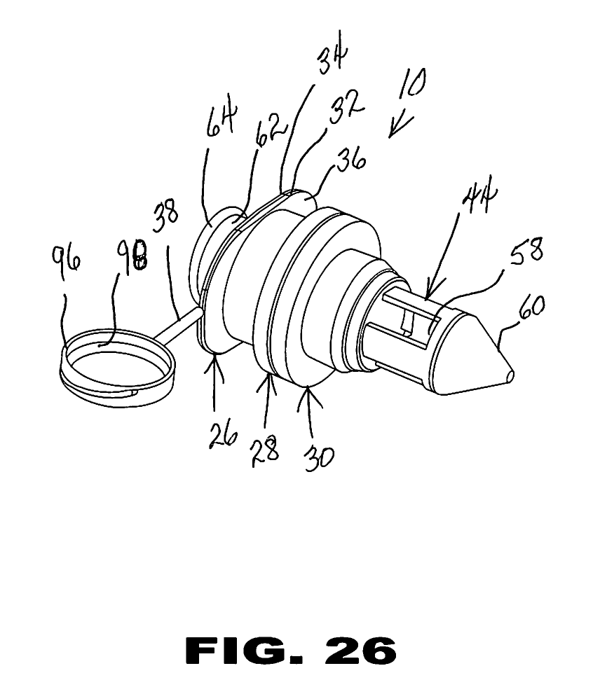

Referring to FIG. 26, shown is an assembled perspective view of an enablement of the plunger of the present invention. Illustrated is the plunger 26 having arm 38 and cap 96 with channel 98 and tab 100 for closing the plunger sleeve conduit 54. The plunger further provides flange 32 having top surface 34 and bottom surface 36 with conduit 44 having bore 54 extending from collar 62 through end 52. Also shown is plunger 28 having a burstable membrane 74 and plunger tip 60 positioned within conduit 44 end 52 so that pressure applied to plunger 26 causes tip 60 to break member 74 providing access to the coconut's contents. Also shown is conduit 44 having a plurality of wall slits 58.

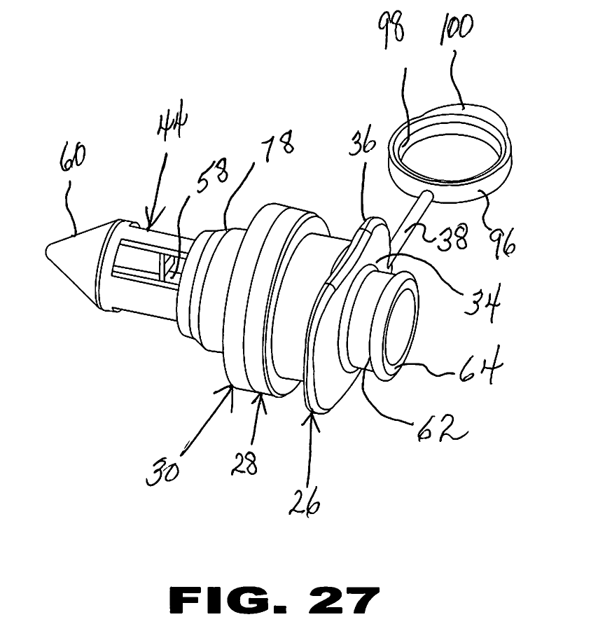

Referring to FIG. 27, shown is an assembled perspective view of an enablement of the plunger of the present invention. Illustrated is the plunger 26 having arm 38 and cap 96 with channel 98 and tab 100 for closing the plunger sleeve conduit 54. The plunger further provides flange 32 having top surface 34 and bottom surface 36 with conduit 44 having bore 54 extending from collar 62 through end 52. Also shown is plunger 28 having a burstable membrane 74 and plunger tip 60 positioned within conduit 44 end 52 so that pressure applied to plunger 26 causes tip 60 to break member 74 providing access to the coconut's contents. Also shown is conduit 44 having a plurality of wall slits 58.

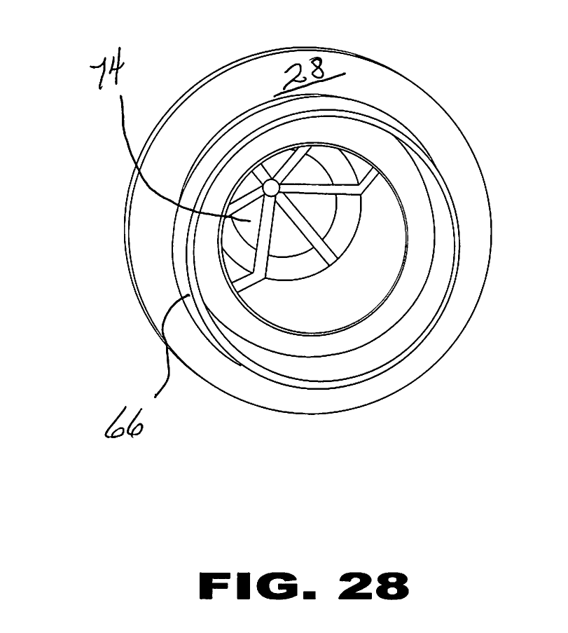

Referring to FIG. 28 shown is another illustrative view of an embodiment of the spigot sleeve. Sleeve 28 has flange 66 with opposing side collars extending therefrom with a burstable membrane 74 sealing the spigot until pressure is applied to the spigot causing the plunger to burst membrane 74.

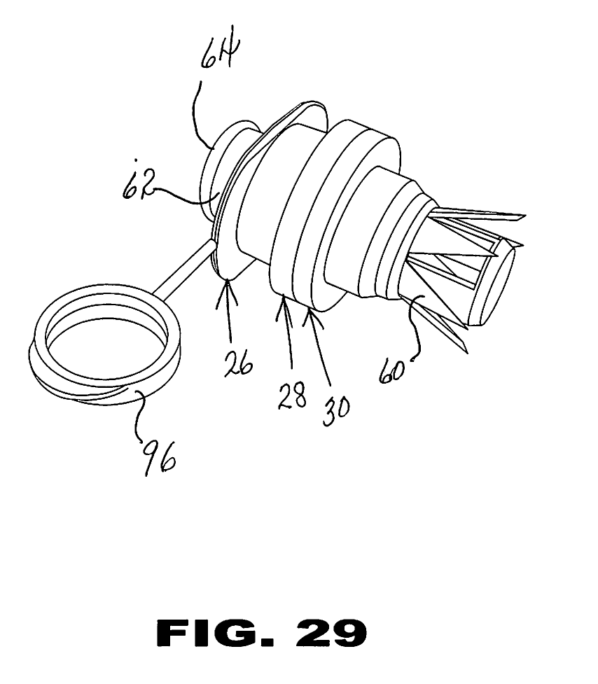

Referring to FIG. 29, shown is an assembled view of the coconut spigot plunger deployed. Depicted is the coconut spigot 10 comprising plunger 26, sleeve 28 and grommet 30. Grommet 30 has flange 82 and collar 84 with ridges 86 with the grommet seated within a cavity drilled within the coconut wall. Sleeve 28 has bore 80 with sleeve membrane 60 burst by conduit 44 thereby providing access to the coconut water.

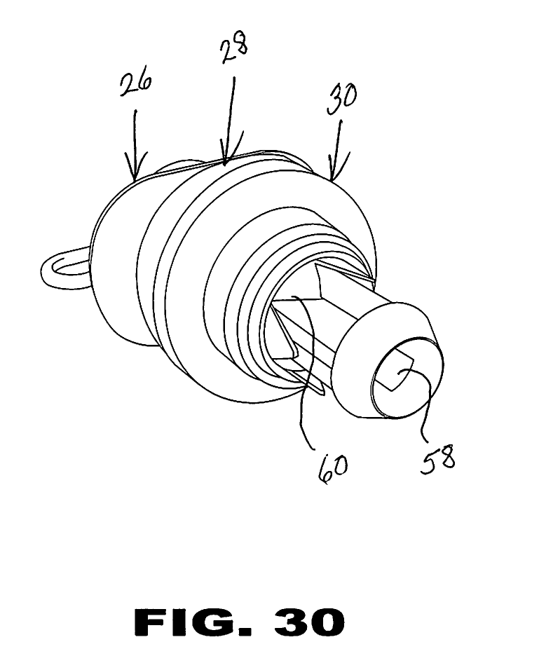

Referring to FIG. 30, shown is an assembled view of the coconut spigot plunger deployed. Depicted is the coconut spigot 10 comprising plunger 26, sleeve 28 and grommet 30. Grommet 30 has flange 82 and collar 84 with ridges 86 with the grommet seated within a cavity drilled within the coconut wall. Sleeve 28 has bore 80 with sleeve membrane 60 burst by conduit 44 thereby providing access to the coconut water.

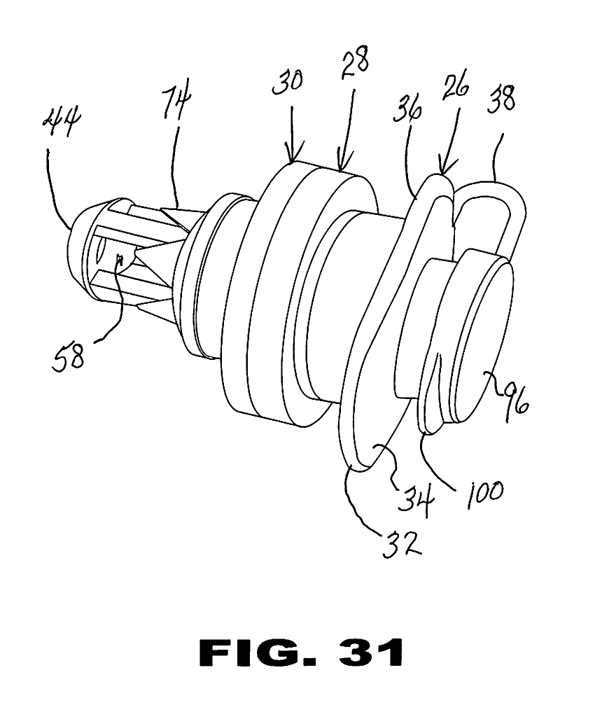

Referring to FIG. 31, shown is an assembled view of the coconut spigot plunger deployed. Depicted is the coconut spigot 10 comprising plunger 26, sleeve 28 and grommet 30. Grommet 30 has flange 82 and collar 84 with ridges 86 with the grommet seated within a cavity drilled within the coconut wall. Sleeve 28 has bore 80 with sleeve membrane 60 burst by conduit 44 thereby providing access to the coconut water.

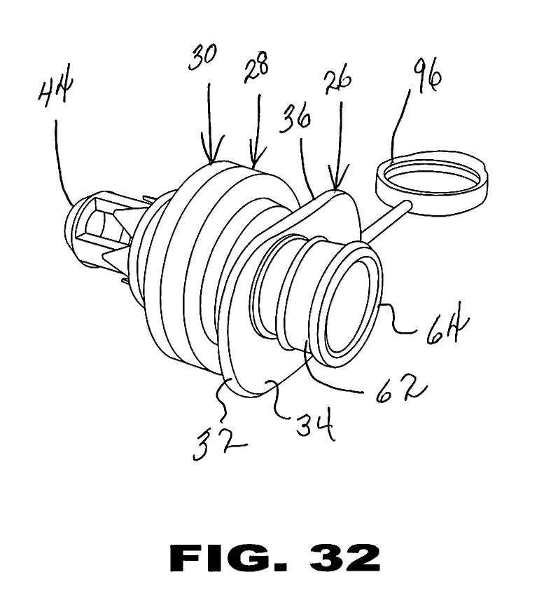

Referring to FIG. 32, shown is an assembled view of the coconut spigot plunger deployed. Depicted is the coconut spigot 10 comprising plunger 26, sleeve 28 and grommet 30. Grommet 30 has flange 82 and collar 84 with ridges 86 with the grommet seated within a cavity drilled within the coconut wall. Sleeve 28 has bore 80 with sleeve membrane 60 burst by conduit 44 thereby providing access to the coconut water.

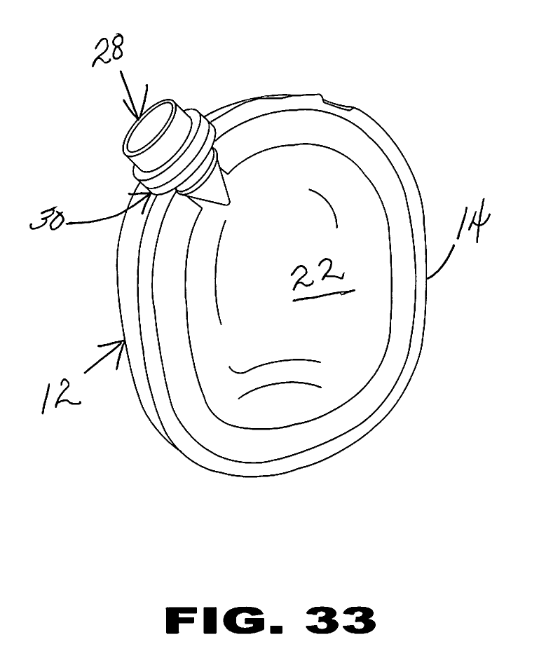

Referring to FIG. 33, shown is a coconut having a value positioned within a cavity. The present invention 10 provides means for a consumer to easily extract the coconut water of coconut 12 from coconut cavity 22 by inserting a spigot 10 comprising plunger 26, sleeve 28 and plunger 30 within a cavity drilled in the coconut wall so that pressure applied to the plunger will pierce the sleeve 28 membrane 74 providing access to the coconut water within the seed-case cavity.

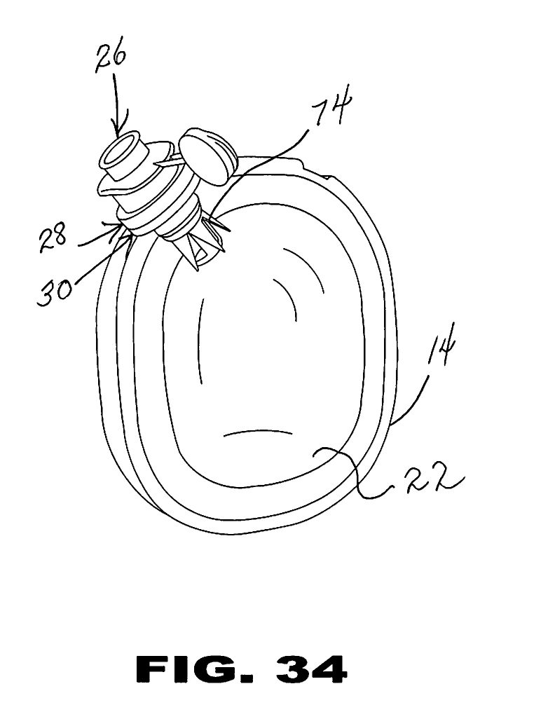

Referring to FIG. 34, shown is a coconut having a value positioned within a cavity. The present invention 10 provides means for a consumer to easily extract the coconut water of coconut 12 from coconut seed case cavity 22 by inserting a spigot 10 comprising plunger 26, sleeve 28 and plunger 30 within a cavity drilled in the coconut wall so that pressure applied to the plunger will pierce the sleeve 28 membrane 74 providing access to the coconut water within the seed-case cavity.

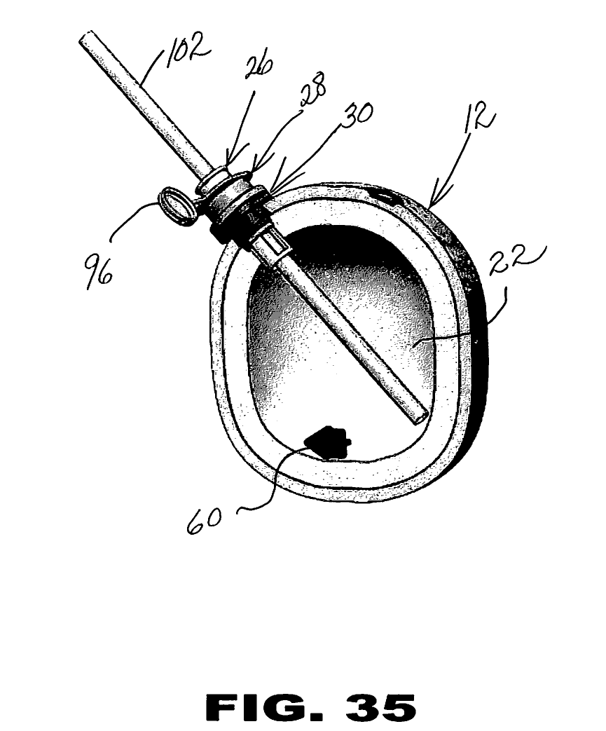

Referring to FIG. 35, shown is another enablement of the coconut spigot of the present invention. Illustrated is the spigot 10 comprising plunger 26, sleeve 28 and grommet 30 with the plunger conduit 44 having tip 60 therein. When cap 96 is removed from plunger collar 62 providing access to bore 80 then straw 102 can be positioned within bore 80 where a force will push tip 60 into the coconut seed-case cavity with the straw used to retrieve the coconut water.

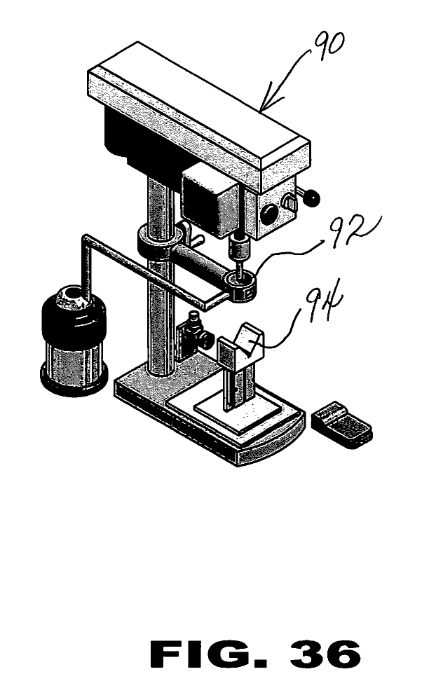

Referring to FIG. 36, shown is an illustrative view of the boring machine of the present invention. The present invention provides a food grade boring machine 90 having a boring machine workpiece holder 94 and boring machine bit 92 for boring a cavity within the wall of the coconut for placement of the spigot 10 therein.

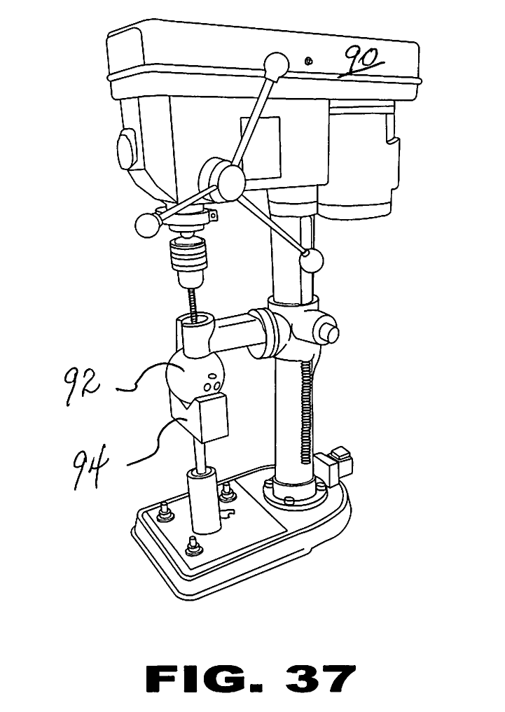

Referring to FIG. 37, shown is a perspective view of the boring machine of the present invention. Illustrated is a food grade boring machine 90 having stainless steel parts for creating a spigot cavity within coconut 12. The boring machine 90 has a workpiece holder for holding a coconut and a boring machine bit 92 for manufacturing a cavity within the coconut wall of a predetermine diameter and depth.

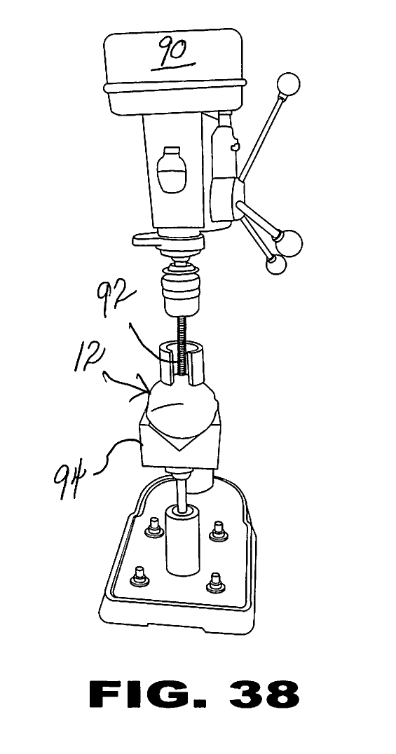

Referring to FIG. 38, shown is a front view of the boring machine of the present invention. Illustrated is a food grade boring machine 90 having stainless steel parts for creating a spigot cavity within coconut 12. The boring machine 90 has a workpiece holder for holding a coconut and a boring machine bit 92 for manufacturing a cavity within the coconut wall of a predetermine diameter and depth.

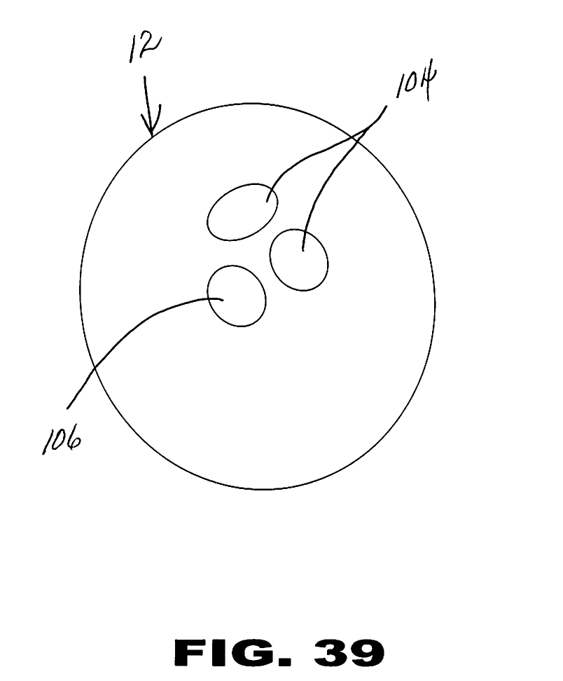

Referring to FIG. 39, shown is an illustrative view of a coconut. A coconut 12 has three eyes 104 with two of the them called blind eyes and the third called a soft eye 106, which has served as the nutrient umbilical cord between the tree and coconut during growth and is quite soft. The present invention provides for a spigot positioned over the soft eye 104 whereby a plunger force will provide access to the coconut within the seed-case cavity.

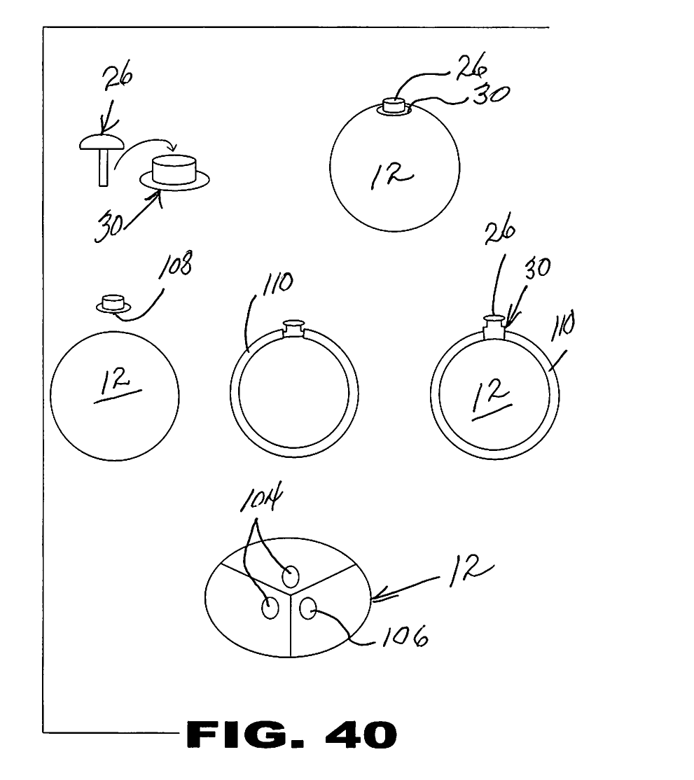

Referring to FIG. 40, shown is an illustrative view of a spigot for a coconut soft eye. As aforementioned, a coconut 12 has three eyes 104 with two of the them called blind eyes and the third called a soft eye 106, which has served as the nutrient umbilical cord between the tree and coconut during growth and is quite soft. The present invention provides for a spigot comprising a grommet 30 bonded 108 over the soft eye 104 with a plunger 26 within said grommet so that a force applied to the plunger will provide access to the coconut water within the seed-case cavity. Further provided is a band 110 fixedly attached to grommet 30.

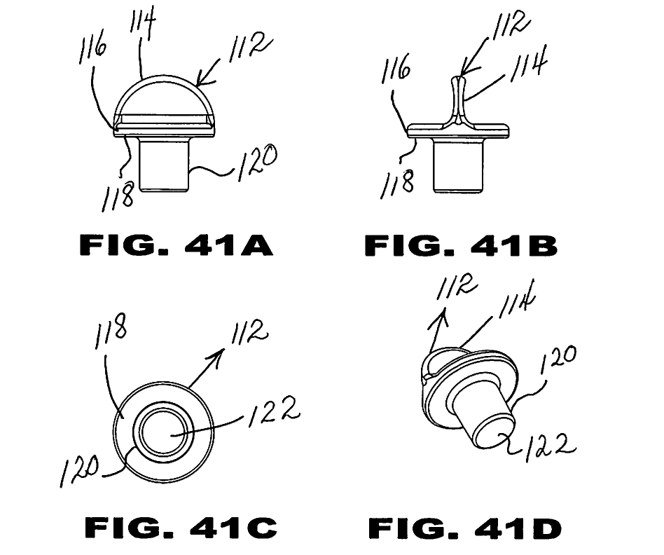

Referring to FIG. 41A through 41D, shown is an illustrative view of a coconut aperture plug. Plug 112 sits within grommet 30 to prevent contamination of the coconut aperture. Plug 112 having handle 114 used to manipulate plug 112 has flange 116 with bottom surface 118 that engages grommet flange 82 while collar 120 engages grommet bore 88 thereby sealing the coconut aperture.

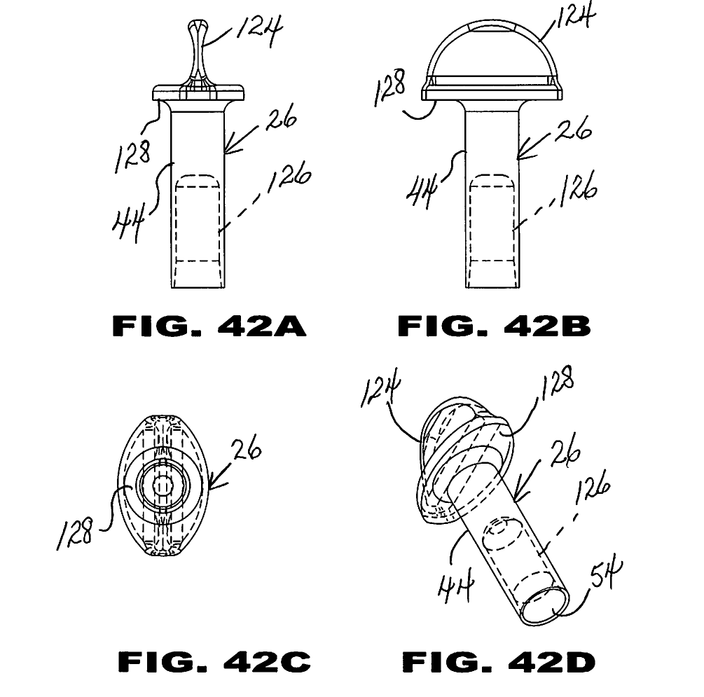

Referring to FIG. 42A through 42D shown is an illustrative view of additional embodiment of the plunger. Plunger 26 incorporates an additional element comprising handle 124 forming a plunger grip. The plunger further provides coring cavity 126 within conduit sleeve 44. Also provided is plunger stop 128 and conduit 44 that respectively engage grommet 30 and grommet bore 88 when seated therein.

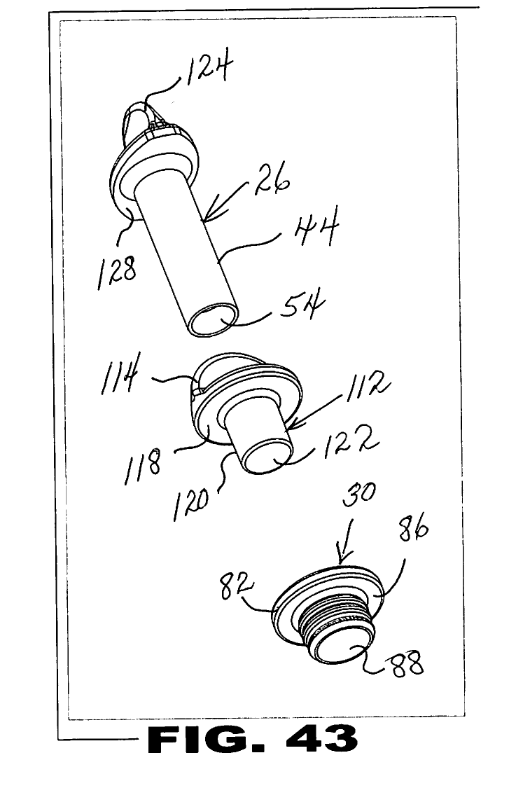

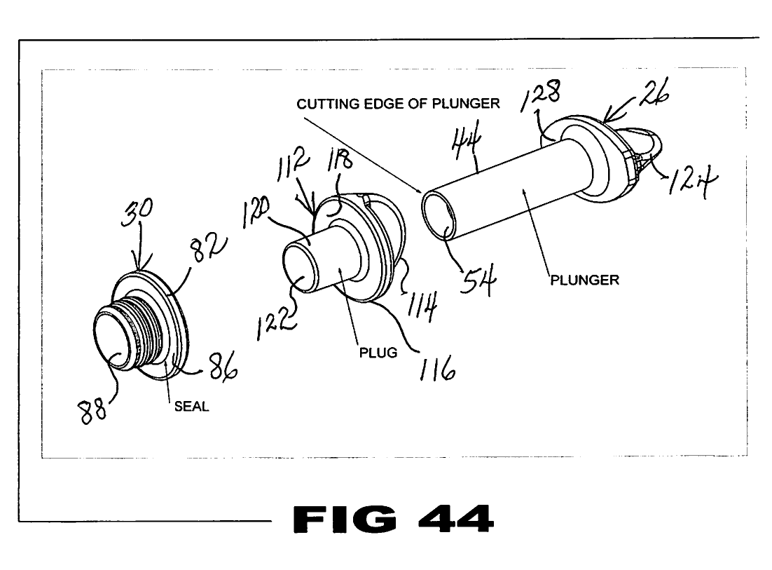

Referring to FIGS. 43 and 44, shown are exploded views of an enablement of the coconut spigot of the present invention. Depicted is the coconut spigot 10 comprising plunger 26, plug 112 and grommet 30. Grommet 30 has flange 82 and collar 84 with ridges 86 forming a gasket that will frictionally engage the wall of a coconut's milled cavity, wherethen plunger 26 having conduit 44 with coring cavity 126 is inserted into grommet 30 so that the coring cavity 126 is seated within the coconut meat until removed by the consumer, which will provide access to the coconut water. Also provided is plug 112 that is inserted into the coconut bore as a stopper to preserve the coconut's contents for later consumption.

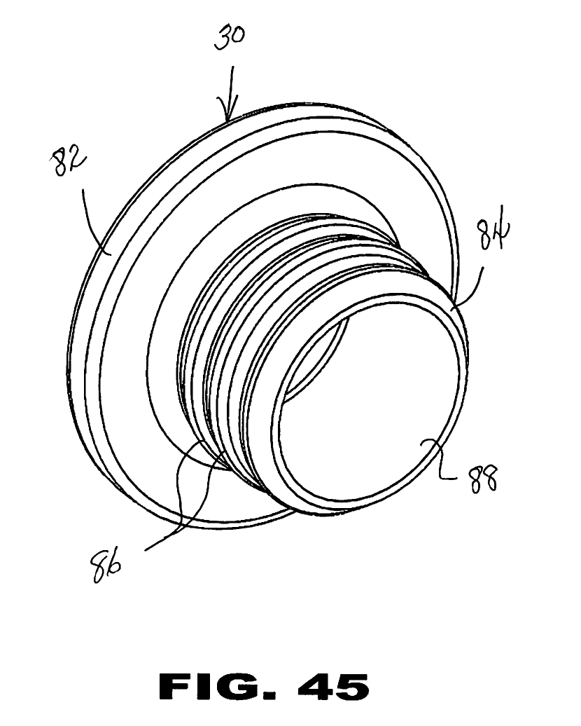

Referring to FIG. 45, shown is an illustrative view of an embodiment of the spigot grommet. Grommet 30 comprises flange 82 having collar 84 extending therefrom with circumferential ridges 86 serving as frictional elements for engaging the wall of the milled coconut aperture when placed therein.

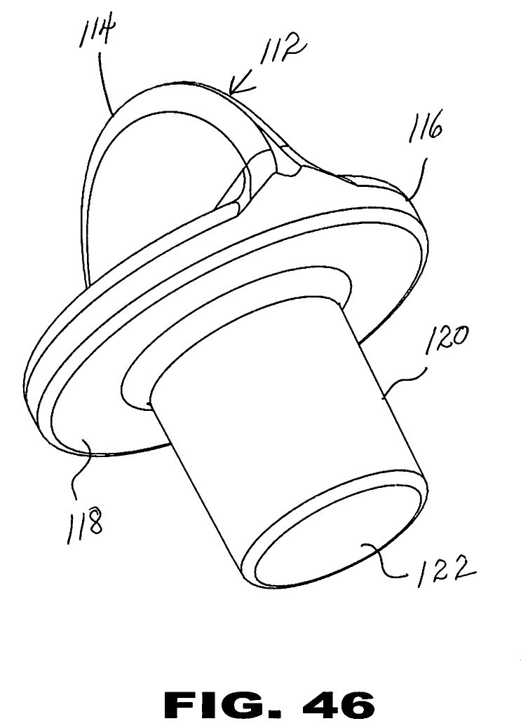

Referring to FIG. 46, shown is an illustrative view of a coconut aperture plug. Plug 112 having handle 114 used to manipulate plug 112 has flange 116 with bottom surface 118 that engages grommet flange 82 while collar 120 engages grommet bore 88 thereby sealing the coconut aperture with plug 112 sitting within grommet 30 prevents contamination of the coconut aperture.

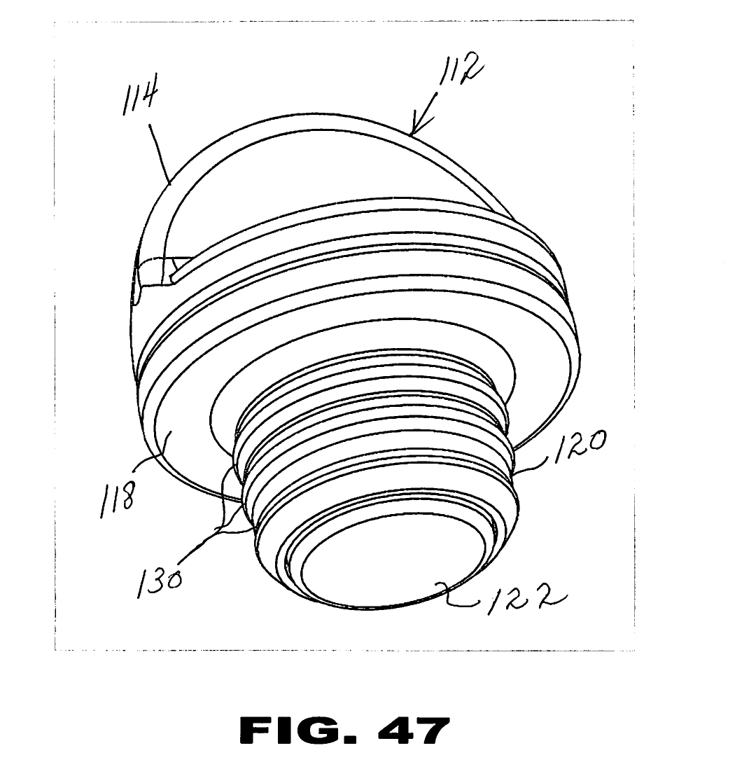

Referring to FIG. 47, shown is an illustrative view of another enablement of the coconut aperture plug. Plug 112 having handle 114 used to manipulate plug 112 has flange 116 with bottom surface 118 that engages grommet flange 82 while collar 120 further incorporates circumferential ridges that will frictional engage grommet bore 88 thereby sealing the coconut aperture from contamination of the coconut aperture.

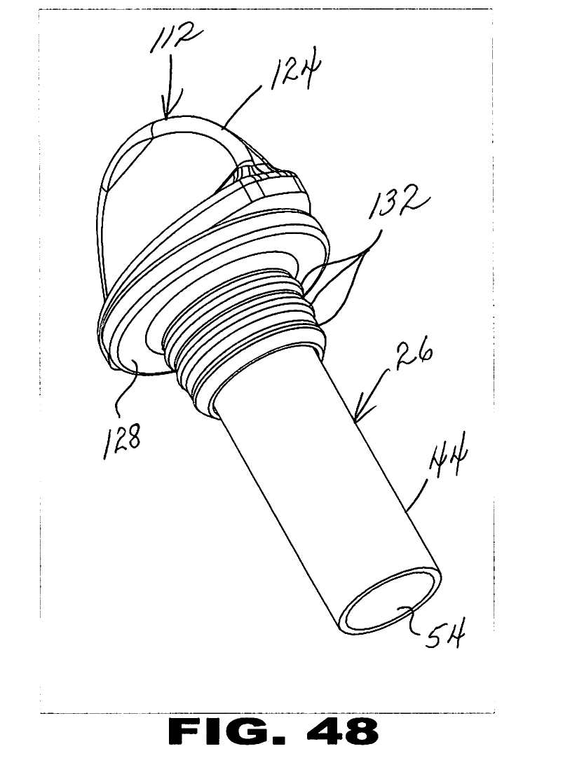

Referring to FIG. 48 shown is an illustrative view of a plunger seated within a grommet. Plunger 26 incorporates handle 124 forming a plunger grip. The plunger further provides coring cavity 126 within conduit sleeve 44. Also provided is plunger stop 128 and conduit 44 that respectively engage grommet 30 and grommet bore 88 when seated therein.

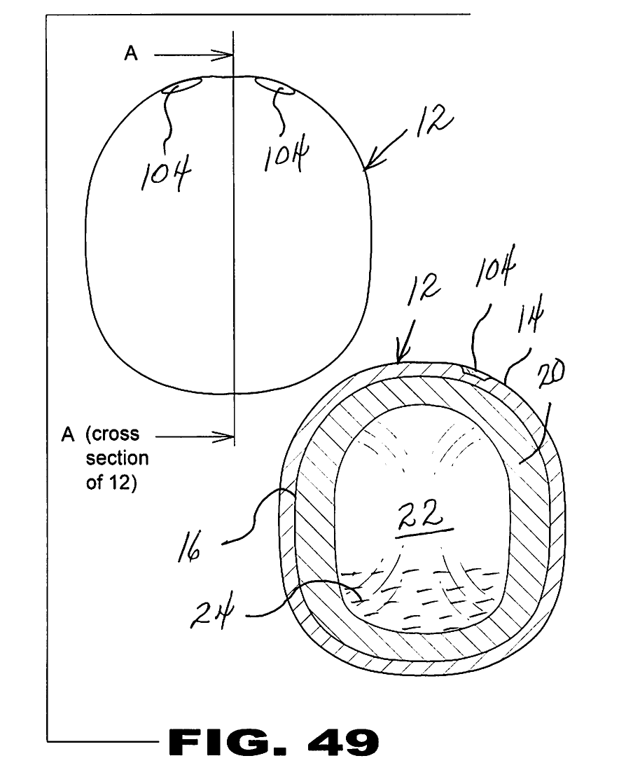

Referring to FIG. 49, shown is an illustrative view of a coconut. Depicted is a coconut 12 having coconut eyes 104. The coconut comprises husk 14 and coconut seed 16 encasing coconut meat 20 encompassing coconut seed-case cavity 22 having coconut water 24 within.

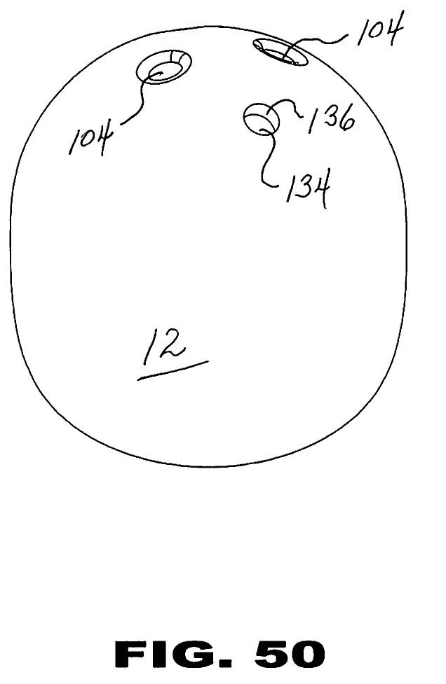

Referring to FIG. 50, shown is a coconut with a milled bore. Depicted is coconut 12 having coconut eyes 104 having milled aperture 134 and aperture wall 136 that will receive grommet therein.

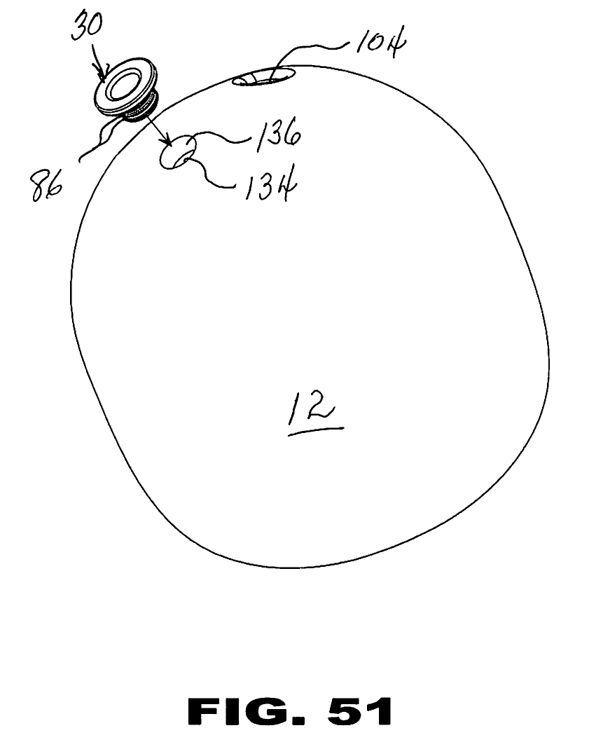

Referring to FIG. 51, shown is a coconut with a milled bore and grommet. Depicted is coconut 12 having coconut eyes 104 with milled aperture 134 and aperture wall 136 with grommet 30 ready to be inserted into said coconut aperture.

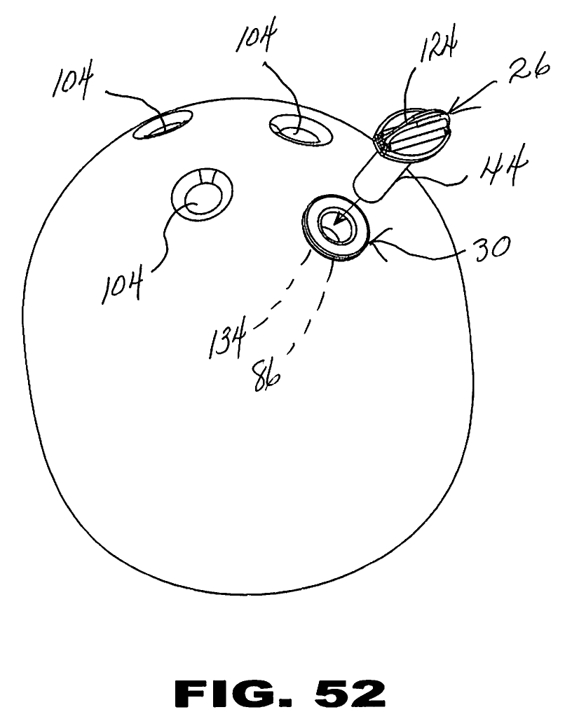

Referring to FIG. 52, shown is a coconut with a seated grommet. Depicted is coconut 12 having coconut eyes 104 with milled aperture 134 and aperture wall 136 with grommet 30 positioned within said coconut cavity with plunger 26 having handle 124 and conduit 44 is ready to be seated within said grommet.

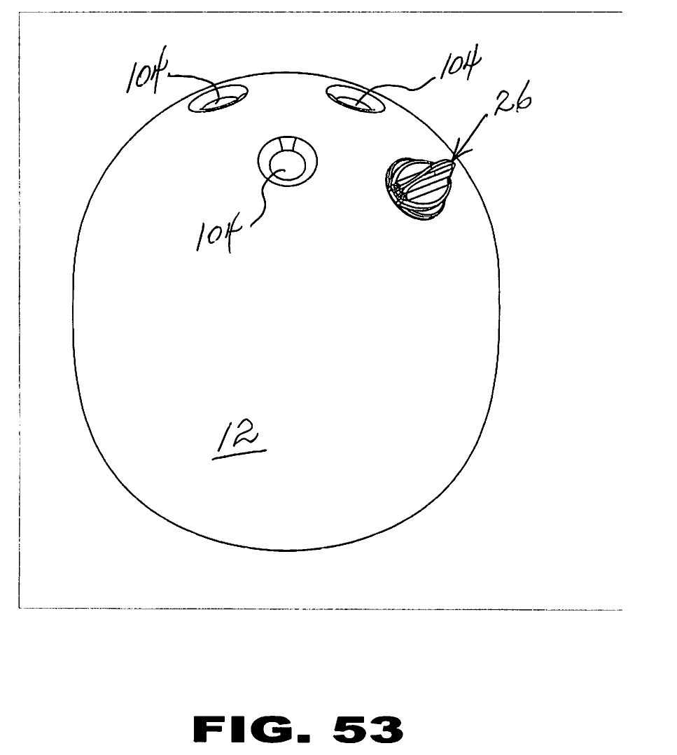

Referring to FIG. 53, shown is a coconut with a seated grommet and plunger. Depicted is coconut 12 having coconut eyes 104 with milled aperture 134 and aperture wall 136 with grommet 30 positioned within said coconut cavity with plunger 26 having handle 124 and conduit 44 seated within said grommet 30.

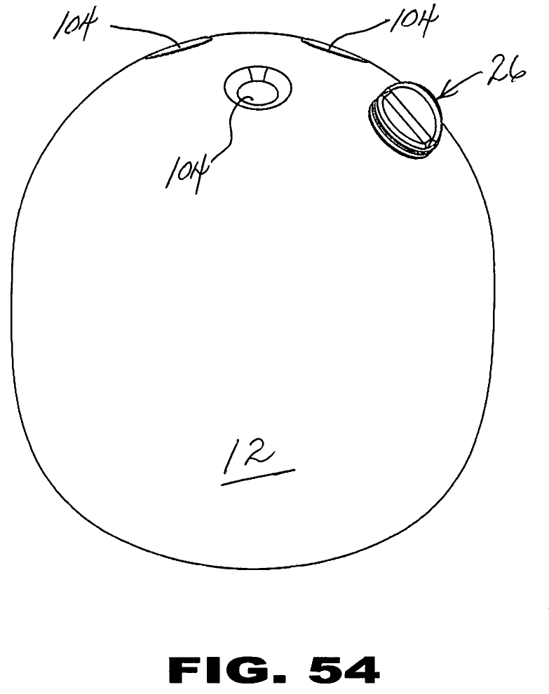

Referring to FIG. 54, shown is a coconut with a seated grommet and plunger. Depicted is coconut 12 having coconut eyes 104 with milled aperture 134 and aperture wall 136 with grommet 30 positioned within said coconut cavity with plunger 26 having handle 124 and conduit 44 seated within said grommet 30.

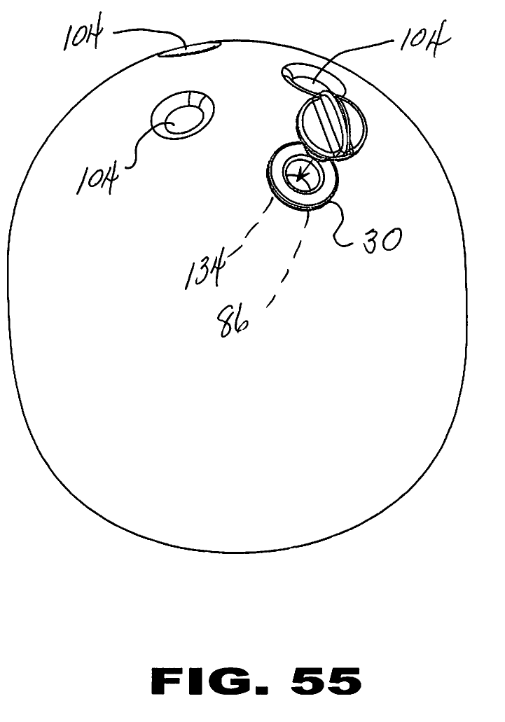

Referring to FIG. 55, shown is a coconut with a seated grommet. Depicted is coconut 12 having coconut eyes 104 with milled aperture 134 and aperture wall 136 with grommet 30 positioned within said coconut cavity with plunger 26 having handle 124 and conduit 44 is ready to be seated within said grommet.

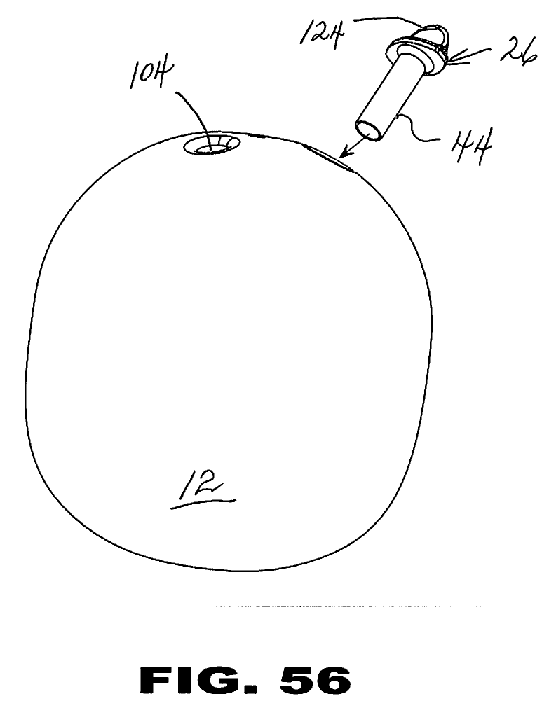

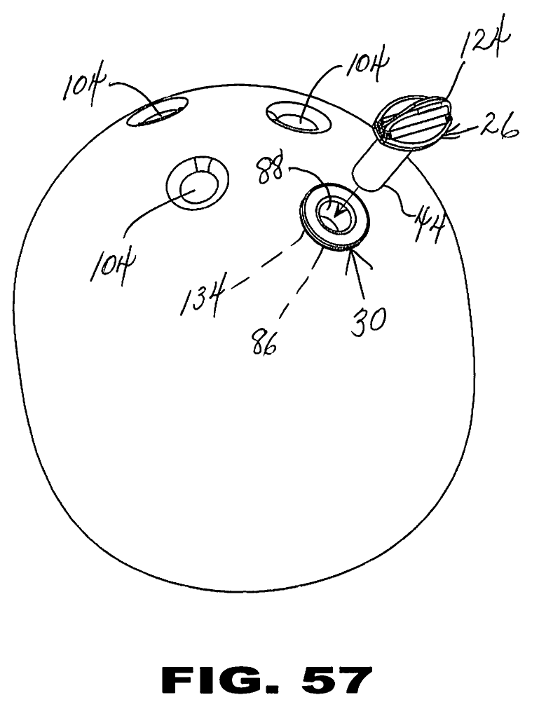

Referring to FIGS. 56 and 57, shown is a coconut with a seated grommet. Depicted is coconut 12 having coconut eyes 104 with milled aperture 134 and aperture wall 136 with grommet 30 positioned within said coconut cavity with plunger 26 having handle 124 and conduit 44 is ready to be seated within said grommet.

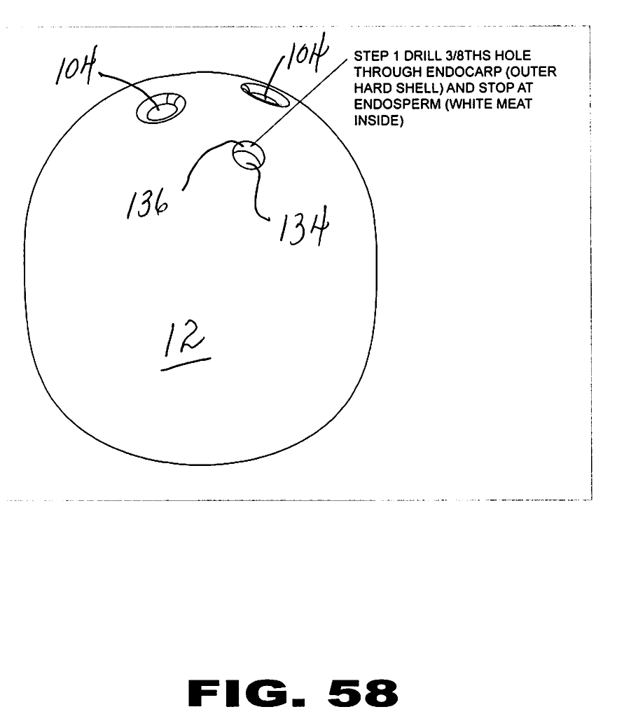

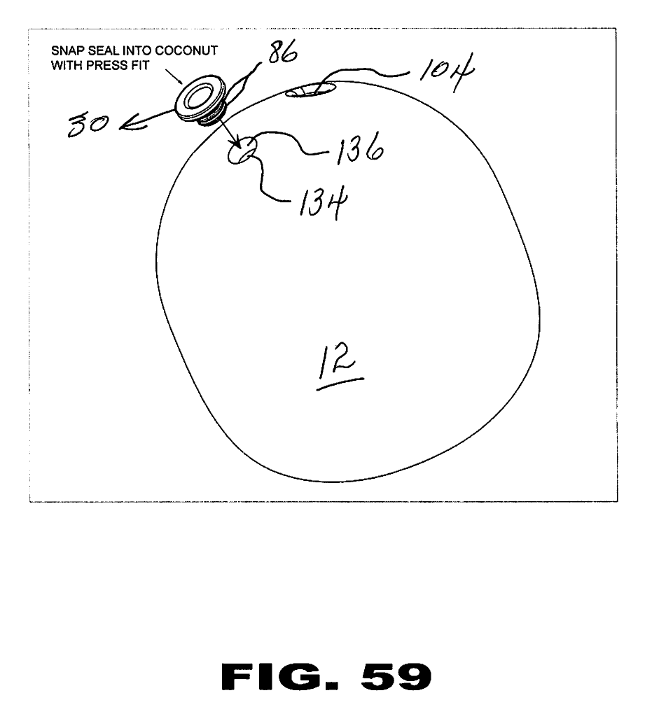

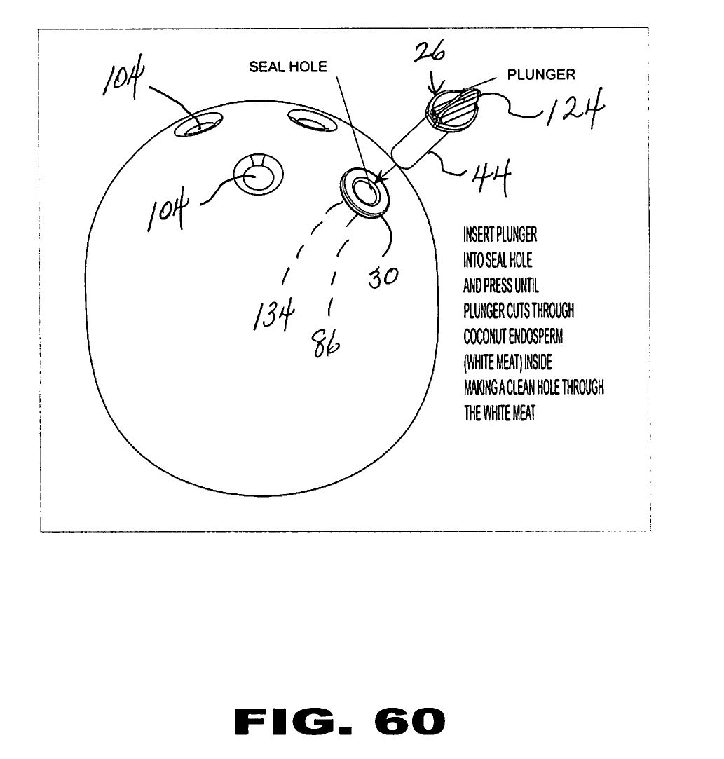

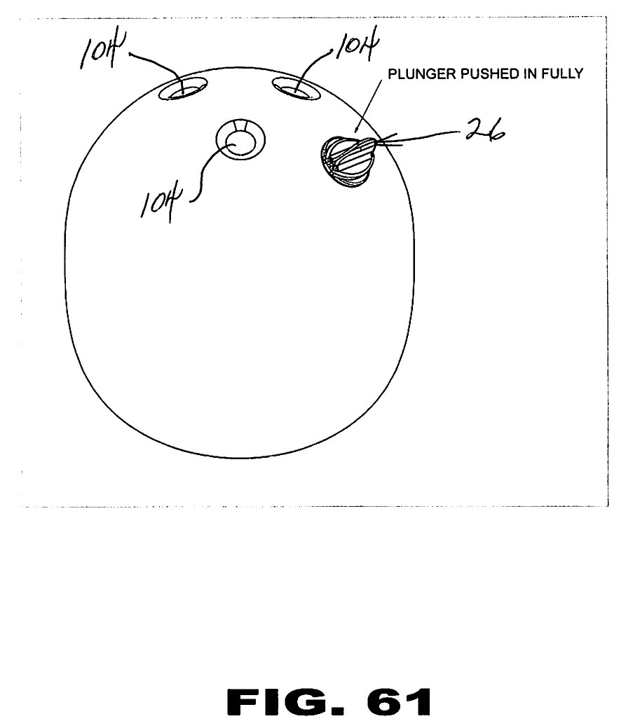

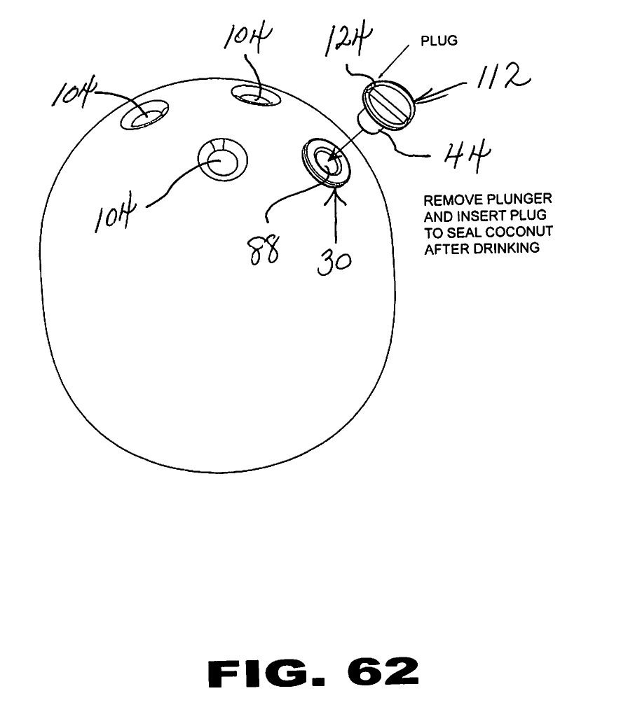

Referring to FIGS. 58 through 62, shown is a progression of illustrations of the method for accessing coconut water. Shown is a coconut 12 having coconut eyes 14 wherethen a milled aperture 134 of predetermined diameter and depth is created without milling through the coconut's endosperm. Once milled grommet 30 having collar 84 with circumferential ridges 86 is then inserted aperture 134, where grommet ridges 86 frictional engage aperture wall 136 thereby sealing aperture 134 from contamination. Plunger 26 having handle 124 is then inserted into grommet bore 88 with plunger 26 having conduit 44 with bore 54 that will cut through the coconut endosperm (white meat) making a clean hole through the white meat. When desired the plunger 26 is removed from the coconut grommet bore 88, which removes the cored white meat providing access to the coconut water. Further provided is a plug 112 having conduit 44 and handle 124 that is inserted into grommet bore 88 to reseal the spigot until desired.

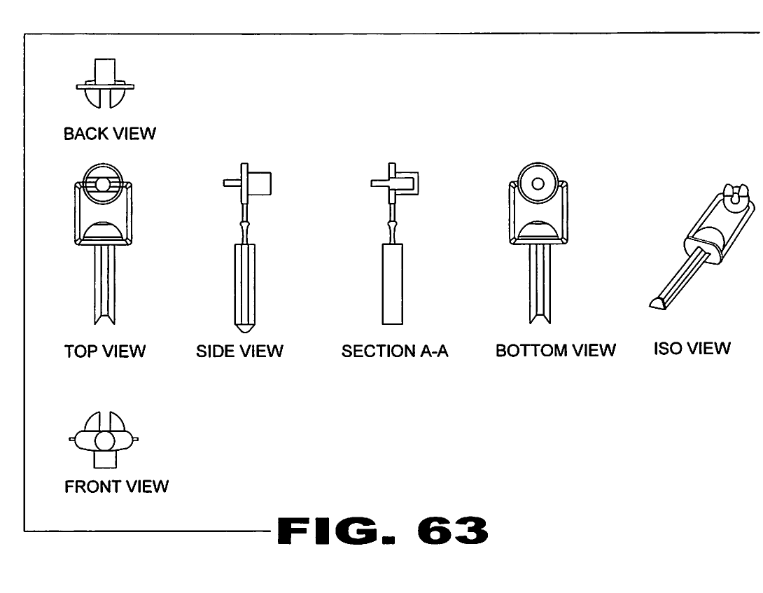

Referring to FIG. 63, shown is another enablement of a coconut spigot of the present invention. The spigot 10 of the present invention provide an alternate embodiment 136 of the spigot of the present invention. Depicted is a shaft-like plunger having a terminus cutting head.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A method for hygienically attaching a spigot to a coconut to selectively remove the sterile water from the coconut through the spigot comprising:
a) means for tooling a cavity within the coconut;
b) means for fixating the coconut in a desired orientation during cavity tooling; and
c) means for securing the spigot within the coconut cavity.

2. A method for creating a cavity within a coconut as recited in claim 1, wherein the means for creating a cavity within the coconut is a food grade boring machine having a bit for tooling a cavity within the coconut husk that terminates at a predetermined point within the meat of the coconut.

3. A method for fixating the coconut in a desired orientation during tooling as recited in claim 1, where the coconut is positioned within the food grade boring machine workpiece holder during the boring task.

4. A method for securing the spigot within the coconut cavity as recited in claim 1, where the means for securing the spigot within the coconut cavity is a spigot compression fitting having a bore extending between a flange and a collar with a plurality of external ring-like ridges for frictionally engaging the wall of the cavity and the flange forming stop abutting the rim of the cavity.

5. A method for selectively removing the sterile water from the coconut through the spigot as recited in claim 1 where the spigot further comprises a sleeve for movably securing a plunger therein; and, a plunger for breeching the seed-case cavity when manual pressure is applied thereto providing access to the coconut water.

6. A method for selectively removing the sterile water from the coconut through the spigot as recited in claim 5 where the spigot alternately provides a spiked tip for breeching the seed-case cavity to access the coconut water.

7. A method for selectively removing the sterile water from the coconut through the spigot as recited in claim 6, further comprising a straw insertable through the spigot into the coconut water for retrieving said coconut water through said straw.

8. A spigot for accessing and removing the sterile water within a coconut comprising:
a) a grommet having a flange and a collar with said flange positioned within a tooled coconut cavity.
b) a sleeve having a bore with a flange having opposing transverse collars with one of the collars insertable into the grommet and the other serving as seat for a plunger; and
c) a plunger positioned within and movable in the sleeve whereby manual pressure applied to the plunger breeches the seed-case cavity to access the coconut water therein.

9. A spigot for accessing and removing the sterile water within a coconut as recited in claim 8, wherein said grommet collar has compressible external ring-like ridges so that when the grommet is positioned within the tooled coconut cavity the collar ridges frictionally engage the interior wall of the coconut cavity.

10. A spigot for accessing and removing the sterile water within a coconut as recited in claim 9, where the grommet when placed within the tooled coconut cavity cause the flange to engage the exterior lip of the tooled cavity.

11. A spigot for accessing and removing the sterile water within a coconut as recited in claim 10, wherein said sleeve has a flange with opposing side transverse collars one of the collars that is insertable into the grommet has a terminal end flange that is positioned outside of the grommet bore when placed therein forming seat for said grommet.

12. A spigot for accessing and removing the sterile water within a coconut as recited in claim 11, wherein said sleeve alternately provides a membrane positioned approximate the grommet's terminal end flange thereby forming a hermetic seal within said spigot to protect the coconut water within said coconut from contamination.

13. A spigot for accessing and removing the sterile water within a coconut as recited in claim 11, where the opposing sleeve collar forms receptacle for the plunger sleeve seat gasket.

14. A spigot for accessing and removing the sterile water within a coconut as recited in claim 13, wherein said plunger has a flange with a conduit depending therefrom having a plunger sleeve seat gasket circumscribed about the conduit flange end.

15. A spigot for accessing and removing the sterile water within a coconut as recited in claim 14, wherein said plunger has a bore whereby pressure applied to the plunger flange breeches the coconut seed-case cavity thereby establishing fluid communication between the coconut's tooled cavity and the seed-case cavity having the sterile coconut water therein.

16. A spigot for accessing and removing the sterile water within a coconut as recited in claim 15, wherein said plunger having a flange further provides a grip tethered to said flange to aid in applying manual pressure to the plunger flange.

17. A spigot for accessing and removing the sterile water within a coconut as recited in claim 16, wherein said plunger conduit additional provides for slits placed within the plunger conduit wall.

18. A spigot for accessing and removing the sterile water within a coconut as recited in claim 17, wherein said plunger conduit alternately provides for a detachable tip used to breech the seed-case cavity wherethen the tip will fall into the seed-case cavity creating a spigot conduit.

19. A spigot for accessing and removing the sterile water within a coconut as recited in claim 18, further comprising a straw insertable through the spigot into the seed-case cavity having the coconut water therein for retrieving said coconut water through said straw.

20. A spigot for accessing and removing the sterile water within a coconut as recited in claim 19, further comprising a plunger flange with a top side collar having a bore extending the length of the plunger.

21. A spigot for accessing and removing the sterile water within a coconut as recited in claim 17, further comprising a flange tethered cap forming spigot conduit closure for any remaining coconut water within the seed-case cavity.

22. A spigot for accessing and removing the sterile water within a coconut comprising:
a) a coconut having a soft eye which has served as its nutrient umbilical cord during growth;
b) a grommet having a flange portion and a collar portion with a bore extending therebetween with said flange portion fixedly attached over said soft eye; and
c) a plunger positioned within said grommet collar whereby manual pressure applied to the plunger causes the plunger to breech the seed-case cavity via said coconut's soft eye.

23. A spigot for accessing and removing the sterile water within a coconut as recited in claim 22, wherein said grommet is adhesively bonded over the coconut's soft eye.

24. A spigot for accessing and removing the sterile water within a coconut as recited in claim 22, wherein said grommet is mechanically bonded over the coconut's soft eye by a strap circumferentially extending around the coconut between opposing sides of the grommet.
